(19) United States
(12) Patent Application Publication
(10) Pub. No.: US 2025/0356570 A1
(43) Pub. Date: Nov. 20, 2025

(54) VIRTUAL OBJECT MOTION GENERATION METHOD AND APPARATUS, AND COMPUTER DEVICE

(71) Applicant: Tencent Technology (Shenzhen) Company Limited, Shenzhen (CN)

(72) Inventors: Yang WU, Shenzhen (CN); Peng JIN, Shenzhen (CN); Yanbo FAN, Shenzhen (CN); Zhongqian SUN, Shenzhen (CN); Wei YANG, Shenzhen (CN)

(73) Assignee: Tencent Technology (Shenzhen) Company Limited, Shenzhen (CN)

(21) Appl. No.: 19/289,390

(22) Filed: Aug. 4, 2025

Related U.S. Application Data
(63) Continuation of application No. PCT/CN2024/098388, filed on Jun. 11, 2024.

(30) Foreign Application Priority Data
Aug. 3, 2023 (CN) 202310970212.1

(51) Int. Cl. G06T 13/40; G06F 40/205; G06F 40/30

(52) U.S. Cl. CPC G06T 13/40; G06F 40/205; G06F 40/30

(57) ABSTRACT

This disclosure relates to a virtual object motion generation method and apparatus, and a computer device. The method includes: parsing the motion description text to obtain respective motion description information of the plurality of semantic levels; separately encoding the motion description information of the plurality of semantic levels to obtain respective motion description representations of the plurality of semantic levels; performing denoising processing at the first semantic level on the sampled noise signal based on a motion description representation of the first semantic level, to obtain a motion eigenvector; performing, at each semantic level after the first semantic level, denoising processing on the sampled noise signal based on a motion eigenvector and respective motion description representations of at least two semantic levels from the first semantic level to the current semantic level, to obtain a motion eigenvector; and decoding the motion eigenvector to obtain the virtual object motion.

### RELATED APPLICATION

This application is a continuation application of PCT Patent Application No. PCT/CN2024/098388, filed on Jun. 11, 2024, which claims priority to Chinese Patent Application No. 202310970212.1, entitled “VIRTUAL OBJECT MOTION GENERATION METHOD AND APPARATUS, COMPUTER DEVICE, AND STORAGE MEDIUM” filed with the China National Intellectual Property Administration on Aug. 3, 2023, wherein the content of the above-referenced applications is incorporated herein by reference in its entirety.

### FIELD OF THE TECHNOLOGY

This disclosure relates to the field of computer technologies, and in particular, to a virtual object motion generation method and apparatus, a computer device, a computer-readable storage medium, and a computer program product.

### BACKGROUND OF THE DISCLOSURE

With the development of computer technologies, a text-driven virtual object motion generation technology emerges. In the technology, a virtual object motion may be generated by using a segment of motion description text for describing a virtual object.

In a conventional technology, a common virtual object motion generation method is: inputting motion description text as a control signal to a generative model (for example, a generative adversarial network, a variational autoencoder, or a diffusion model), to directly map the motion description text to a virtual object motion by using the generative model.

However, because the motion description text is directly mapped to the virtual object motion in the conventional method, generally, only a coarse-grained virtual object motion can be generated, resulting in a problem that the generated virtual object motion is inaccurate.

### SUMMARY

Embodiments of this disclosure provide a virtual object motion generation method and apparatus, a computer device, a computer-readable storage medium, and a computer program product.

A virtual object motion generation method is provided. The method is performed by a computer device, and includes: obtaining motion description text for describing a virtual object motion; parsing the motion description text at a plurality of preset semantic levels through semantic analysis to obtain respective motion description information of the plurality of semantic levels, and obtaining a sampled noise signal for generating the virtual object motion; separately encoding the motion description information of the plurality of semantic levels to obtain respective motion description representations of the plurality of semantic levels; performing denoising processing at the first semantic level in the plurality of semantic levels on the sampled noise signal based on a motion description representation of the first semantic level, to obtain a motion eigenvector outputted by the first semantic level; performing, at each semantic level after the first semantic level in the plurality of semantic levels, denoising processing on the sampled noise signal based on a motion eigenvector outputted by a previous semantic level and respective motion description representations of at least two semantic levels from the first semantic level to the current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level; and decoding the motion eigenvector obtained through the cascade denoising, to obtain the virtual object motion.

A virtual object motion generation apparatus is provided. The apparatus includes: a memory operable to store computer-readable instructions; and a processor circuitry operable to read the computer-readable instructions, the processor circuitry when executing the computer-readable instructions is configured to: obtain motion description text for describing a virtual object motion; parse the motion description text at a plurality of preset semantic levels through semantic analysis to obtain respective motion description information of the plurality of semantic levels, and obtain a sampled noise signal for generating the virtual object motion; separately encode the motion description information of the plurality of semantic levels to obtain respective motion description representations of the plurality of semantic levels; perform denoising processing at the first semantic level in the plurality of semantic levels on the sampled noise signal based on a motion description representation of the first semantic level, to obtain a motion eigenvector outputted by the first semantic level; perform, at each semantic level after the first semantic level in the plurality of semantic levels, denoising processing on the sampled noise signal based on a motion eigenvector outputted by a previous semantic level and respective motion description representations of at least two semantic levels from the first semantic level to the current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level; and decode the motion eigenvector obtained through the cascade denoising, to obtain the virtual object motion.

A non-transitory machine-readable media, having instructions stored on the machine-readable media, the instructions configured to, when executed, cause a machine to: obtain motion description text for describing a virtual object motion; parse the motion description text at a plurality of preset semantic levels through semantic analysis to obtain respective motion description information of the plurality of semantic levels, and obtain a sampled noise signal for generating the virtual object motion; separately encode the motion description information of the plurality of semantic levels to obtain respective motion description representations of the plurality of semantic levels; perform denoising processing at the first semantic level in the plurality of semantic levels on the sampled noise signal based on a motion description representation of the first semantic level, to obtain a motion eigenvector outputted by the first semantic level; perform, at each semantic level after the first semantic level in the plurality of semantic levels, denoising processing on the sampled noise signal based on a motion eigenvector outputted by a previous semantic level and respective motion description representations of at least two semantic levels from the first semantic level to the current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level; and decode the motion eigenvector obtained through the cascade denoising, to obtain the virtual object motion.

One or more nonvolatile computer-readable storage media storing computer-readable instructions are provided, having the computer-readable instructions stored therein. The computer-readable instructions, when executed by one or more processors, enable the one or more processors to perform the operations in the foregoing virtual object motion generation method.

A computer program product or a computer program is provided. The computer program product or the computer program includes computer-readable instructions, and the computer-readable instructions are stored in a computer-readable storage medium. One or more processors of a computer device read the computer-readable instructions from the computer-readable storage medium, and the one or more processors execute the computer-readable instructions, to enable the computer device to perform the operations in the foregoing virtual object motion generation method.

Details of one or more embodiments of this disclosure are provided in the accompanying drawings and descriptions below. Other features, objectives, and advantages of this disclosure become apparent in the specification, the drawings, and the claims.

### BRIEF DESCRIPTION OF THE DRAWINGS

To describe technical solutions in the embodiments of this disclosure or the related art more clearly, the following briefly describes the accompanying drawings required for describing the embodiments or the related art. Apparently, the accompanying drawings in the following descriptions show only some embodiments of this disclosure, and a person of ordinary skill in the art may still derive other accompanying drawings from these accompanying drawings without creative efforts.

FIG. 1 is a diagram of an application environment of a virtual object motion generation method according to an embodiment.

FIG. 2 is a schematic flowchart of a virtual object motion generation method according to an embodiment.

FIG. 3 is a schematic diagram of denoising processing at the first semantic level according to an embodiment.

FIG. 4 is a schematic diagram of obtaining a motion eigenvector that is obtained through cascade denoising according to an embodiment.

FIG. 5 is a schematic diagram of a virtual object motion sequence according to an embodiment.

FIG. 6 is a schematic diagram of motion description information of a plurality of semantic levels according to an embodiment.

FIG. 7 is a schematic diagram of a hierarchical semantic graph according to an embodiment.

FIG. 8 is a schematic diagram of a hierarchical semantic graph according to another embodiment.

FIG. 9 is a schematic diagram of generating an adjusted virtual object motion through edge weight adjustment according to an embodiment.

FIG. 10 is a schematic diagram of a denoising processing process of obtaining a motion eigenvector outputted by the first semantic level according to an embodiment.

FIG. 11 is a schematic diagram of predicting added noise corresponding to a noising step according to an embodiment.

FIG. 12 is a schematic diagram of a structure of a pre-trained motion sequence generation model according to an embodiment.

FIG. 13 is an overall framework diagram of a virtual object motion generation method according to an embodiment.

FIG. 14 is a structural block diagram of a virtual object motion generation apparatus according to an embodiment.

FIG. 15 is a diagram of an internal structure of a computer device according to an embodiment.

### DESCRIPTION OF EMBODIMENTS

To make the objectives, technical solutions, and advantages of this disclosure clearer, the following further describes this disclosure in detail with reference to the accompanying drawings and the embodiments. The specific embodiments described herein are only used for explaining this disclosure, and are not used for limiting this disclosure.

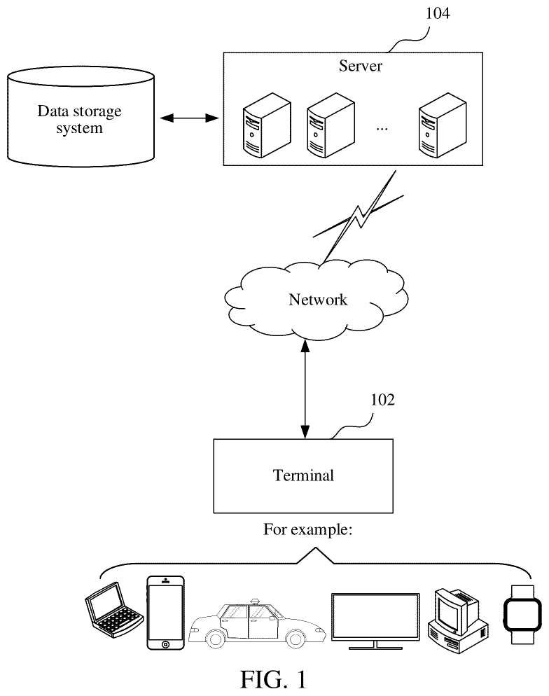

A virtual object motion generation method provided in the embodiments of this disclosure may be applied to an application environment shown in FIG. 1. A terminal 102 communicates with a server 104 through a network. A data storage system may store data that the server 104 needs to process. The data storage system may be integrated into the server 104, or may be deployed on cloud or another server. The server 104 obtains motion description text for describing a virtual object motion; parses the motion description text at a plurality of preset semantic levels through semantic analysis to obtain respective motion description information of the plurality of semantic levels, and obtains a sampled noise signal for generating the virtual object motion; separately encodes the motion description information of the plurality of semantic levels to obtain respective motion description representations of the plurality of semantic levels; performs denoising processing at the first semantic level in the plurality of semantic levels on the sampled noise signal based on a motion description representation of the first semantic level, to obtain a motion eigenvector outputted by the first semantic level; performs, at each semantic level after the first semantic level in the plurality of semantic levels, denoising processing on the sampled noise signal based on a motion eigenvector outputted by a previous semantic level and respective motion description representations of at least two semantic levels from the first semantic level to the current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level; decodes the motion eigenvector obtained through the cascade denoising, to obtain the virtual object motion; and pushes the virtual object motion to the terminal 102 for display.

The terminal 102 may be, but not limited to, a desktop computer, a notebook computer, a smartphone, a tablet computer, an Internet of things device, and a portable wearable device. The Internet of things device may be a smart speaker, a smart television, a smart air conditioner, a smart in-vehicle device, and the like. The portable wearable device may be a smart watch, a smart band, a head-mounted device, and the like. The server 104 may be implemented by an independent server or a server cluster that includes multiple servers.

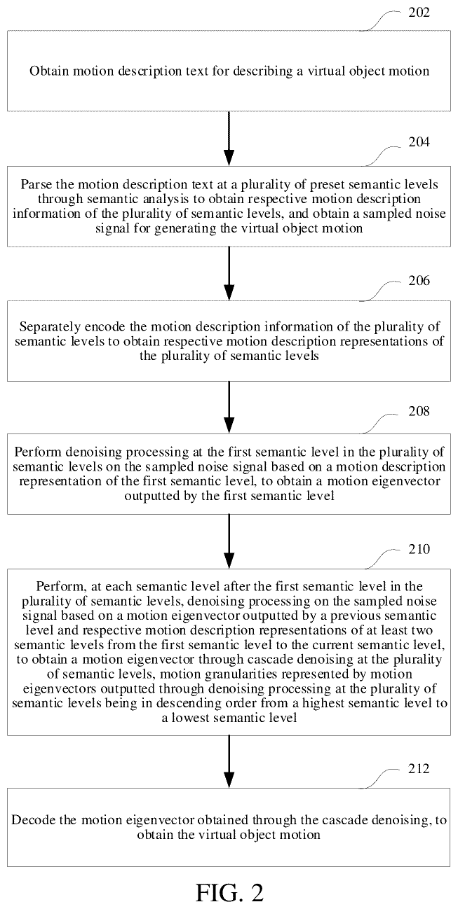

In an embodiment, as shown in FIG. 2, a virtual object motion generation method is provided. The method may be performed by a terminal or a server alone, or may be jointly performed by a terminal and a server. In this embodiment of this disclosure, an example in which the method is applied to the server is used for description. The method includes the following operations:

Operation 202: Obtain motion description text for describing a virtual object motion.

A virtual object is a movable object in a virtual environment. The movable object may be a virtual person, a virtual animal, or the like. For example, when the virtual environment is a three-dimensional (3D) virtual environment, the virtual object is a virtual person, a virtual animal, or the like displayed in the 3D virtual environment. The virtual object has a shape and a volume in the 3D virtual environment, and occupies a part of space in the 3D virtual environment. The virtual environment is provided when a client runs on the terminal. The virtual environment may be a simulated environment of the real world, may be a semi-simulated and semi-fictional environment, or may be a purely fictional environment. For example, the virtual environment may be specifically the 3D virtual environment.

The virtual object motion is a motion generated when the virtual object moves in the virtual environment. For example, the virtual object motion may be specifically walking forward, first standing up and then walking forward, walking rightward, or jumping forward. The motion description text is text for describing the virtual object motion. The motion description text may include information such as a motion type, a movement path, and a motion style. The motion type is a type to which the virtual object motion belongs. For example, the motion type may be specifically walking, running, or jumping. The movement path indicates a movement direction of the virtual object. For example, the movement path may be specifically in a forward direction, a leftward direction, a rightward direction, or the like. The motion style indicates a state of the virtual object when the virtual object moves. For example, the motion style may be specifically a happy state or a sad state. For example, the motion description text may be specifically that a person walks forward, then turns left, and then continues to walk rightward. The person herein is the virtual object.

Specifically, when the virtual object motion needs to be generated, the server obtains the motion description text for describing the virtual object motion, to generate the virtual object motion according to the information such as the motion type, the movement path, and the motion style in the motion description text. In a specific application, the generation of the virtual object motion in this application may be widely applied to scenarios such as augmented reality (AR)/virtual reality (VR) content production, game content production, and 3D animation design to efficiently produce vivid and diversified virtual object motions.

Operation 204: Parse the motion description text at a plurality of preset semantic levels through semantic analysis to obtain respective motion description information of the plurality of semantic levels, and obtain a sampled noise signal for generating the virtual object motion.

The semantic analysis means analyzing a meaning of each word in the motion description text, to determine a structure of the motion description text, a part of speech of each word in the motion description text, and the like. For example, the structure of the motion description text may be specifically in a form of (attribute) subject+(adverbial) predicate+(complement or attribute)+object. For another example, a part of speech of a word in the motion description text may be specifically a noun, a verb, an adverb, an adjective, a preposition, or the like.

The semantic level is a perspective for describing the virtual object motion. The plurality of semantic levels are used for describing the virtual object motion from a plurality of different perspectives, and different semantic levels focus on different perspectives. The virtual object motion is described from the plurality of different perspectives by using the plurality of semantic levels, so that the virtual object motion can be fully described. In this embodiment, the plurality of semantic levels may be preset according to an actual application scenario. For example, the plurality of semantic levels may specifically include a global motion level, a local motion level, and a motion detail level. The global motion level is mainly used for globally describing the virtual object motion, the local motion level is mainly used for describing the virtual object motion by using several local motions included in the virtual object motion, and the motion detail level is mainly used for describing the virtual object motion by using details of the several local motions.

The motion description information of the semantic level is information for describing the virtual object motion at the semantic level. For example, if the semantic level is the global motion level, the motion description information of the semantic level may be specifically information for globally describing the virtual object motion. For another example, if the semantic level is the local motion level, the motion description information of the semantic level may be specifically verbs representing the several local motions included in the virtual object motion. For still another example, if the semantic level is the motion detail level, the motion description information of the semantic level may be specifically a modifier for modifying verbs representing the several local motions included in the virtual object motion.

The sampled noise signal is a noise signal obtained through random sampling when the virtual object motion needs to be generated. For example, the sampled noise signal may be specifically a Gaussian noise signal obtained through random sampling when the virtual object motion needs to be generated.

Specifically, the semantic analysis may be specifically semantic role parsing. In this case, the server parses the motion description text at the plurality of preset semantic levels through the semantic role parsing to obtain the motion description information of the plurality of semantic levels, and obtains, through the random sampling, the sampled noise signal for generating the virtual object motion. Semantic roles are different roles played by different sentence components (such as a subject, an object, time, and a place) in a motion event when the event is described in a sentence. Names of the roles are usually nouns or verbs in a verb phrase. In this embodiment, the semantic roles are different roles played by different sentence components (such as a subject, an object, time, and a place) in the motion description text. Which semantic role a sentence component plays depends on a predicate verb.

In a specific application, when parsing the motion description text at the plurality of preset semantic levels through the semantic role parsing, the server first splits the motion description text into a plurality of different sentence components, identifies a verb from the motion description text, and then determines, based on semantic association relationships between the plurality of different sentence components and the verb, roles played by the different sentence components, to obtain the motion description information of the plurality of semantic levels.

In a specific application, the server may parse the motion description text at the plurality of preset semantic levels through the semantic analysis by using a pre-trained natural language model that is used for semantic parsing, and may obtain the motion description information of the plurality of semantic levels by inputting the motion description text to the pre-trained natural language model that is used for semantic parsing. The pre-trained natural language model that is used for semantic parsing may be trained according to an actual application scenario. For example, the pre-trained natural language model that is used for semantic parsing may be specifically a Bidirectional Encoder Representations from Transformers (BERT) model used for relationship extraction and semantic role labeling.

In a specific application, the server may alternatively parse the motion description text at the plurality of preset semantic levels through the semantic analysis by using a semantic role parsing tool, and may obtain the motion description information of the plurality of semantic levels by inputting the motion description text to the semantic role parsing tool. The semantic role parsing tool may be selected according to an actual application scenario. For example, the semantic role parsing tool may be specifically AllenNLP (a Natural Language Processing (NLP) research library based on PyTorch (an open-source Python machine learning library, based on Torch and used for applications such as NLP), used for providing, in various language tasks, deep learning models that are best and most advanced in the industry).

Operation 206: Separately encode the motion description information of the plurality of semantic levels to obtain respective motion description representations of the plurality of semantic levels.

The motion description representation is a feature that can represent the motion description information of the semantic level. For example, the motion description representation is an eigenvector that can represent the motion description information of the semantic level.

Specifically, the server encodes each piece of motion description information of each of the plurality of semantic levels to obtain a first eigenvector of each piece of motion description information, and then obtains the motion description representations of the plurality of semantic levels based on the first eigenvector of each piece of motion description information. The first eigenvector is an eigenvector that can represent content in the motion description information, and the motion description information can be distinguished from other information by using the first eigenvector.

In a specific application, the server may encode each piece of motion description information of each of the plurality of semantic levels by using a pre-trained natural language model that is used for text feature extraction, to obtain the first eigenvector of each piece of motion description information. The pre-trained natural language model that is used for text feature extraction may be trained according to an actual application scenario. For example, the pre-trained natural language model that is used for text feature extraction is specifically a Contrastive Language-Image Pre-Training (CLIP) model. The CLIP model is a pre-trained model, and may be trained by using label-free data. Through the trained CLIP model, a segment of text (or an image) is inputted, and a vector representation of the text (image) is outputted. In this embodiment, the motion description information is inputted, and a vector representation, namely, the first eigenvector, of the motion description information is outputted. Different from other unimodal text models or unimodal image models, the CLIP model is multimodal, and includes content in two aspects, namely, image processing and text processing.

In a specific application, a pre-training task of the CLIP model is to predict whether a given image and given text are a pair, and contrastive learning loss is used. In this embodiment, a contrastive learning method is used to pre-train the CLIP model, and an image and corresponding text are directly used as a whole to determine whether the text and the image are a pair. A main structure of the CLIP model includes a text encoder and an image encoder. During training, the CLIP model respectively inputs an image and text for training to the image encoder and the text encoder to obtain vector representations of the image and the text, then maps the vector representations of the image and the text to a common multimodal space to obtain new vector representations that are of the image and the text and that can be directly compared, and finally calculates a similarity between the vector representations of the image and the text. A target function for the contrastive learning is to make a positive sample pair has a high similarity and a negative sample pair has a low similarity.

In a specific application, after the first eigenvector of each piece of motion description information is obtained, for each semantic level, the server may fuse respective first eigenvectors of at least two pieces of motion description information belonging to the semantic level, and use a fused eigenvector as a motion description representation of the semantic level, to obtain the motion description representations of the plurality of semantic levels. In a specific application, for each semantic level, the server may fuse, through concatenation, superimposition, or the like, respective first eigenvectors of at least two pieces of motion description information belonging to the semantic level.

Further, before fusing the first eigenvectors of the motion description information belonging to the semantic level, the server may further first update the first eigenvector of each piece of motion description information based on a semantic association relationship between at least one pair of motion description information of different semantic levels, to accurately represent each piece of motion description information with reference to contextual content.

Operation 208: Perform denoising processing at the first semantic level in the plurality of semantic levels on the sampled noise signal based on a motion description representation of the first semantic level, to obtain a motion eigenvector outputted by the first semantic level.

The denoising processing means canceling noise in the sampled noise signal. The motion eigenvector outputted by the first semantic level is a vector that can represent a feature of the virtual object motion at the first semantic level.

Specifically, during the denoising processing at the first semantic level in the plurality of semantic levels, the server performs denoising processing at the first semantic level on the sampled noise signal under guidance of the motion description representation of the first semantic level, to reconstruct the motion eigenvector outputted by the first semantic level. In a specific application, the server uses the sampled noise signal as a noise signal on which a plurality of noising steps have been performed, then predicts, based on the motion description representation of the first semantic level, a noise signal added at each of the plurality of noising steps, and performs denoising processing on the sampled noise signal step by step based on the noise signal added at each step, to subtract the noise signal added at each step from the sampled noise signal step by step to obtain the motion eigenvector outputted by the first semantic level.

The motion description representation of the first semantic level exists as a condition for generating the motion eigenvector, and is used for guiding the generation of the motion eigenvector, so that the generated motion eigenvector can be more related to the motion description representation of the first semantic level.

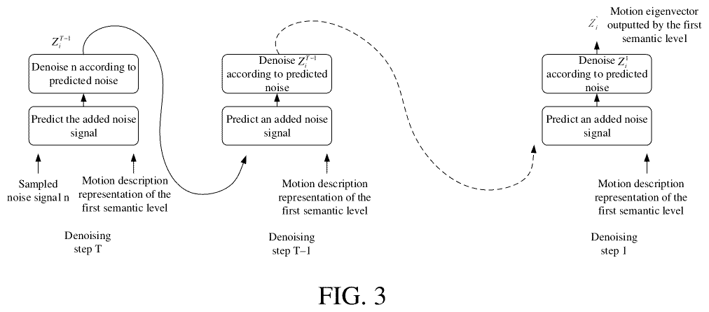

In a specific application, the denoising processing at the first semantic level may be shown in FIG. 3. A sampled noise signal n is used as a noise signal on which a plurality of noising steps (T noising steps shown in FIG. 3) have been performed, predicts, based on the motion description representation of the first semantic level, a noise signal added at each of the plurality of noising steps, and performs denoising processing on the sampled noise signal n step by step based on the noise signal added at each step, to subtract the noise signal added at each step from the sampled noise signal step by step to obtain the motion eigenvector outputted by the first semantic level. As shown in FIG. 3, the server performs, from the last step (a noising step T) in the plurality of noising steps, inverse denoising processing on the inputted noise signal based on the motion description representation of the first semantic level. A noise signal obtained through the denoising at the last step in the plurality of noising steps is zᵢ^{T-1}. A noise signal inputted at the penultimate step (a denoising step T−1) in the plurality of noising steps is the noise signal zᵢ^{T-1} obtained through the denoising that is outputted at the last step (the noising step T). A denoised signal obtained by performing denoising processing on a noise signal (zᵢ¹ shown in FIG. 3) inputted at the first step is the motion eigenvector (zᵢ′ shown in FIG. 3) outputted by the first semantic level.

Operation 210: Perform, at each semantic level after the first semantic level in the plurality of semantic levels, denoising processing on the sampled noise signal based on a motion eigenvector outputted by a previous semantic level and respective motion description representations of at least two semantic levels from the first semantic level to the current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level.

The granularity is a data statistics granularity in a same dimension. In this embodiment, the same dimension is a dimension for describing the virtual object motion. Therefore, the motion granularity is a granularity for describing the virtual object motion, namely, a level of refinement or integration for describing the virtual object motion. A higher level of refinement for describing the virtual object motion indicates a smaller motion granularity represented by the motion eigenvector, and a lower level of refinement for describing the virtual object motion indicates a larger motion granularity represented by the motion eigenvector.

In this embodiment, the motion granularities represented by the motion eigenvectors outputted through the denoising processing at the plurality of semantic levels are in descending order from the highest semantic level to the lowest semantic level. To be specific, a motion granularity represented by the motion eigenvector outputted through the denoising processing at the first semantic level serving as the highest semantic level is the largest, and motion granularities represented by motion eigenvectors outputted by semantic levels after the first semantic level are in descending order of the semantic levels, in other words, the motion granularities decrease semantic level by semantic level. A smaller motion granularity indicates a higher level of refinement for describing the virtual object motion by the motion eigenvector, to be specific, a finer motion granularity indicates that motion details with richer granularities can be included.

Specifically, the server performs, at each semantic level after the first semantic level in the plurality of semantic levels, denoising processing on the sampled noise signal based on the motion eigenvector outputted by the previous semantic level and the motion description representations of the at least two semantic levels from the first semantic level to the current semantic level, to obtain the motion eigenvector that is obtained through cascade denoising at the plurality of semantic levels. In a specific application, during denoising processing at each semantic level after the first semantic level, the server uses the sampled noise signal as a noise signal on which a plurality of noising steps have been performed, predicts, based on the motion eigenvector outputted by the previous semantic level and the motion description representations of the at least two semantic levels from the first semantic level to the current semantic level, a noise signal added at each of the plurality of noising steps, and performs denoising processing on the sampled noise signal step by step based on the noise signal added at each step, to obtain a motion eigenvector outputted by the semantic level.

In a specific application, during the denoising processing at each semantic level after the first semantic level, the server performs, from the last step in the plurality of noising steps based on the motion eigenvector outputted by the previous semantic level and the motion description representations of the at least two semantic levels from the first semantic level to the current semantic level, inverse denoising processing on the noise signal inputted at each step, and uses a denoised signal obtained by performing denoising processing on a noise signal inputted at the first step in the plurality of noising steps as the motion eigenvector outputted by the semantic level.

In a specific application, during the denoising processing at each semantic level after the first semantic level, for each step in the plurality of noising steps, the server encodes a step ranking of the noising step to obtain a noising step feature; then fuses the noising step feature, the motion eigenvector outputted by the previous semantic level, and the motion description representations of the at least two semantic levels from the first semantic level to the current semantic level to obtain a denoising condition feature; predicts, according to the denoising condition feature and a noise signal inputted at the noising step, noise added at the noising step; and performs, based on the predicted added noise, denoising processing on the noise signal inputted at the denoising step, to obtain a denoised signal.

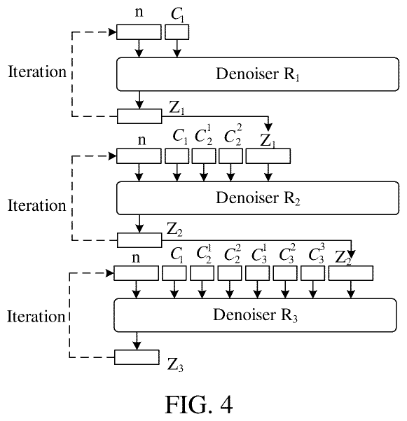

In a specific application, the denoising processing at each semantic level may be implemented by using one denoiser, and the cascade denoising may be specifically performing denoising processing on the sampled noise signal by using a plurality of denoisers connected in series. For example, as shown in FIG. 4, the server may obtain, step by step by using three denoisers R₁,R₂,R₃ connected in series and based on the sampled noise signal n and the motion description representations of the plurality of semantic levels (as shown in FIG. 4, the motion description representation of the first semantic level is C₁, two motion description representations of the second semantic level are C₂¹ and C₂², and three motion description representations of the third semantic level are C₃¹, C₃², and C₃³), the motion eigenvector that is obtained through the cascade denoising. The denoising processing at each semantic level is implemented by performing iterative denoising processing by a denoiser. The denoising processing at the first semantic level is implemented by a denoiser R₁. For each semantic level after the first semantic level, the server performs denoising processing on the sampled noise signal n based on the motion description representations of the at least two semantic levels from the first semantic level to the current semantic level and the motion eigenvector outputted by the previous semantic level (as shown in FIG. 4, the denoiser R₁ outputs Z₁, and the denoiser R₂ outputs Z₂), to obtain the motion eigenvector that is obtained through the cascade denoising (Z₃ outputted by the denoiser R₃ is shown in FIG. 4).

In a specific application, the denoiser R₂ performs denoising processing on the sampled noise signal n by using the motion description representation C₁ of the first semantic level, the motion description representations C₂¹ of the current semantic level, C₂², and Z₁ outputted by the denoiser R₁ as a joint condition, to reconstruct the motion eigenvector Z₂ from the sampled noise signal n. The denoiser R₃ performs denoising processing on the sampled noise signal n by using the motion description representation C₁ of the first semantic level, motion description representations C₂¹ and C₂² of the previous semantic level, the motion description representations C₃¹, C₃², and C₃³ of the current semantic level, and Z₂ outputted by the denoiser R₂ as a joint condition, to reconstruct the motion eigenvector Z₃, namely, the motion eigenvector obtained through the cascade denoising, from the sampled noise signal n.

Operation 212: Decode the motion eigenvector obtained through the cascade denoising, to obtain the virtual object motion.

Specifically, the server decodes the motion eigenvector obtained through the cascade denoising, to obtain the virtual object motion. In a specific application, the decoding the motion eigenvector obtained through the cascade denoising means converting the motion eigenvector obtained through the cascade denoising back to a pose space of the virtual object through mapping, and the obtained virtual object motion may be a virtual object motion sequence. In other words, a corresponding virtual object motion sequence may be generated from given motion description information by using the virtual object motion generation method in this disclosure.

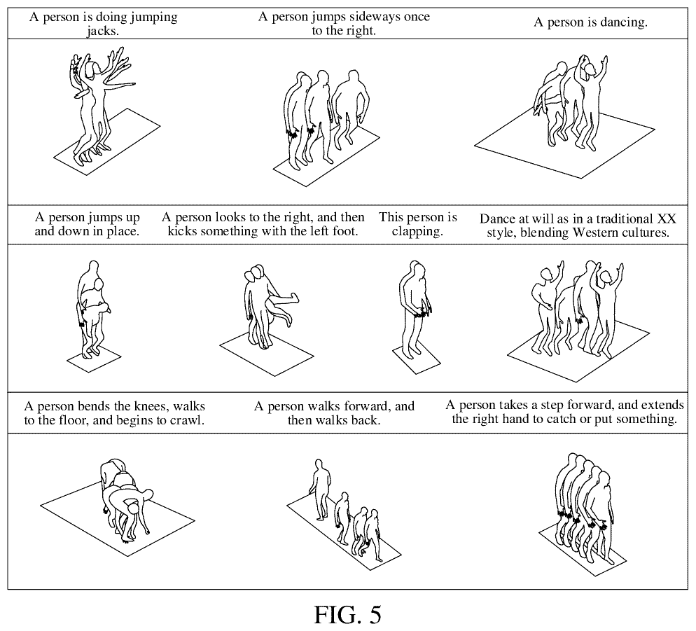

In a specific application, the given motion description information may be in Chinese, or may be text in another language. An example in which the motion description information is used. FIG. 5 shows 10 examples of the corresponding virtual object motion sequence generated from the given motion description information. It may be learned from the example in FIG. 5 that, a high-quality virtual object motion sequence can be generated by using the virtual object motion generation method in this application.

According to the foregoing virtual object motion generation method, the motion description text for describing the virtual object motion is obtained; the motion description text is parsed at the plurality of preset semantic levels through the semantic analysis to obtain the motion description information of the plurality of semantic levels, and the sampled noise signal for generating the virtual object motion is obtained; the motion description information of the plurality of semantic levels is separately encoded to obtain the motion description representations of the plurality of semantic levels; the denoising processing at the first semantic level in the plurality of semantic levels is performed on the sampled noise signal based on the motion description representation of the first semantic level, to obtain the motion eigenvector outputted by the first semantic level; and the denoising processing is performed on the sampled noise signal at each semantic level after the first semantic level in the plurality of semantic levels by using the motion eigenvector outputted by the previous semantic level and the motion description representations of the at least two semantic levels from the first semantic level to the current semantic level as a joint condition, so that fine-grained motion details can be gradually enriched by using the motion description representations of the plurality of semantic levels, to obtain a more fine-grained motion eigenvector that accurately represents the virtual object motion and that is obtained through the cascade denoising at the plurality of semantic levels. Further, the motion eigenvector obtained through the cascade denoising may be decoded, to obtain the virtual object motion. In the entire process, the motion description information of the plurality of semantic levels can be used as fine-grained control signals, and motion features of the plurality of semantic levels are captured to refine the generation of the virtual object motion, to improve accuracy of the generated virtual object motion.

In an embodiment, the plurality of semantic levels include the global motion level, the local motion level, and the motion detail level. The parsing the motion description text at a plurality of preset semantic levels through semantic analysis to obtain respective motion description information of the plurality of semantic levels includes: using the motion description text as motion description information of the global motion level, and extracting, from the motion description text, at least one verb and a verb-modifying phrase respectively corresponding to the at least one verb; and using the at least one verb as motion description information of the local motion level, and using the verb-modifying phrase respectively corresponding to the at least one verb as motion description information of the motion detail level.

The global motion level is mainly used for globally describing the virtual object motion. The globally describing the virtual object motion means describing the virtual object motion from perspectives such as an object performing the virtual object motion, a local motion that is performed, and details of the local motion. The local motion level is mainly used for describing the virtual object motion by using several local motions included in the virtual object motion, and the motion detail level is mainly used for describing the virtual object motion by using details of the several local motions. For example, the details of the local motion may be a direction for performing the virtual object motion and a state of the virtual object when the virtual object motion is performed. The verb-modifying phrase corresponding to the verb is a verb-modifying phrase in a sentence. For example, the verb-modifying phrase related to the verb may be specifically an adjective, an adverb, a preposition, or the like that modifies the verb.

Specifically, the plurality of semantic levels include the global motion level, the local motion level, and the motion detail level. The parsing the motion description text at the plurality of preset semantic levels through the semantic analysis means extracting the motion description information of each semantic level from the motion description text in consideration of the plurality of semantic levels. When extracting the motion description information of the plurality of semantic levels, the server uses the motion description text as the motion description information of the global motion level; extracts, from the motion description text, the at least one verb and the verb-modifying phrase respectively corresponding to the at least one verb; uses the at least one verb as the motion description information of the local motion level; and uses the verb-modifying phrase respectively corresponding to the at least one verb as the motion description information of the motion detail level.

In a specific application, the server may perform part of speech analysis on each word in the motion description text to determine a part of speech of each word to determine the at least one verb, and further may determine, by analyzing a relationship between the at least one verb and each word, the verb-modifying phrase respectively corresponding to the at least one verb.

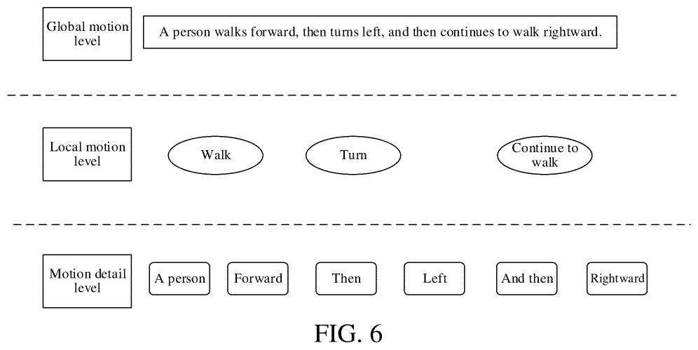

In a specific application, using an example in which the motion description text is “A person walks forward, then turns left, and then continues to walk rightward”, at least one verb that can be extracted from the motion description text includes: “walk”, “turn”, and “continue to walk”. Verb-modifying phrases corresponding to “walk” are “a person” and “forward”, verb-modifying phrases corresponding to “turn” are “a person”, “then”, and “left”, and verb-modifying phrases corresponding to “continue to walk” are “a person”, “and then”, and “rightward”. After parsing is performed at the semantic levels, obtained motion description information of the plurality of semantic levels may be shown in FIG. 6. Motion description information of the global motion level is “A person walks forward, then turns left, and then continues to walk rightward”, motion description information of the local motion level is “walk”, “turn”, and “continue to walk”, and motion description information of the motion detail level is “a person”, “forward”, “then”, “left”, “and then”, and “rightward”.

In this embodiment, in this manner, the motion description information of the global motion level, the local motion level, and the motion detail level can be obtained, so that the motion description information of the plurality of semantic levels can be used as the fine-grained control signals, and the motion features of the plurality of semantic levels are captured to refine the generation of the virtual object motion, to improve the accuracy of the generated virtual object motion.

In an embodiment, the separately encoding the motion description information of the plurality of semantic levels to obtain respective motion description representations of the plurality of semantic levels includes: encoding each piece of motion description information of each of the plurality of semantic levels to obtain a first eigenvector of each piece of motion description information; performing, based on a semantic association relationship between at least one pair of motion description information of different semantic levels, attention mechanism-based update processing on the first eigenvector of each piece of motion description information, to obtain a second eigenvector of each piece of motion description information; and concatenating, for each semantic level, respective second eigenvectors of at least two pieces of motion description information belonging to the semantic level, and using a concatenated second eigenvector as a motion description representation of the semantic level, to obtain the motion description representations of the plurality of semantic levels.

The first eigenvector is a vector that is obtained by encoding the motion description information and that represents the motion description information. The semantic association relationship means that two pieces of motion description information in a pair are semantically associated with each other. For example, when the two pieces of the motion description information are a verb and a verb-modifying modifier, for example, an adverb, an adjective, and a preposition, it may be considered that the two pieces of the motion description information are in the semantic association relationship. The second eigenvector is a vector that is obtained by updating the first eigenvector and that represents the motion description information.

Specifically, the server encodes each piece of motion description information of each of the plurality of semantic levels to obtain the first eigenvector of each piece of motion description information; performs, based on the semantic association relationship between at least one pair of motion description information of different semantic levels, attention mechanism-based update processing on first eigenvectors of motion description information in the semantic association relationship, to obtain an updated second eigenvector of each piece of motion description information; concatenates, for each semantic level, respective second eigenvectors of at least two pieces of motion description information belonging to the semantic level; and uses a concatenated second eigenvector as a motion description representation of the semantic level, to obtain the motion description representations of the plurality of semantic levels.

In a specific application, the server may encode each piece of motion description information of each of the plurality of semantic levels by using the pre-trained natural language model that is used for text feature extraction, to obtain the first eigenvector of each piece of motion description information. During the attention mechanism-based update processing, for each piece of motion description information, the server performs attention mechanism-based interaction processing on the motion description information and a first eigenvector of motion description information in the semantic association relationship with the motion description information, determines attention weight coefficients of the motion description information and the motion description information in the semantic association relationship with the motion description information, and then performs, according to the attention weight coefficients, weighted summation on the motion description information and the first eigenvector of the motion description information in the semantic association relationship with the motion description information, to obtain a second eigenvector of the motion description information.

In this embodiment, the first eigenvector of each piece of motion description information can be obtained through encoding, and the attention mechanism-based update processing is performed on the first eigenvector by using the semantic association relationship, so that the second eigenvector that accurately represents each piece of motion description information can be obtained with full consideration of the motion description information in the semantic association relationship, and the second eigenvectors of the motion description information belonging to the same semantic level can be further concatenated, to obtain the motion description representations of the plurality of semantic levels.

In an embodiment, the performing, based on a semantic association relationship between at least one pair of motion description information of different semantic levels, attention mechanism-based update processing on the first eigenvector of each piece of motion description information, to obtain a second eigenvector of each piece of motion description information includes: using each piece of motion description information as a semantic node, and connecting, based on the semantic association relationship between the at least one pair of motion description information of different semantic levels, two semantic nodes representing a pair of motion description information in the semantic association relationship, to determine connection edges connecting the semantic nodes; using the first eigenvector of each piece of motion description information as a node representation of each semantic node; constructing a hierarchical semantic graph according to each semantic node, the connection edges connecting the semantic nodes, and the node representation of each semantic node; and updating the node representation of each semantic node in the hierarchical semantic graph by using a graph attention mechanism, and obtaining the second eigenvector of each piece of motion description information according to an updated node representation of each semantic node.

The graph attention mechanism is used for introducing an attention mechanism to implement better neighbor aggregation. Weighted aggregation on a neighbor may be implemented by learning a weight of the neighbor. Therefore, memorizing a noisy neighbor by using graph attention is relatively robust, and the attention mechanism also endows a model with particular interpretability. Compared with simple image convolution, the graph attention mechanism further enhances graph-based reasoning by dynamically paying attention to a feature of a neighborhood.

Specifically, the server uses each piece of motion description information as a semantic node, and connects, based on the semantic association relationship between at least one pair of motion description information of different semantic levels, two semantic nodes representing a pair of motion description information in the semantic association relationship (motion description information of different semantic levels), to obtain the connection edges connecting the semantic nodes. Based on this, the server further uses the first eigenvector of each piece of motion description information as the node representation of each semantic node, so that the hierarchical semantic graph can be constructed according to each semantic node, the connection edges connecting the semantic nodes, and the node representation of each semantic node. After constructing the hierarchical semantic graph, the server updates the node representation of each semantic node in the hierarchical semantic graph by using the graph attention mechanism, and uses the updated node representation of each semantic node as the second eigenvector of the motion description information corresponding to the semantic node.

In a specific application, when the node representation of each semantic node in the hierarchical semantic graph is updated by using the graph attention mechanism, for each semantic node in the hierarchical semantic graph, the server determines at least one neighboring node of the semantic node, and updates a node representation of the semantic node by using a node representation of the at least one neighboring node and the node representation of the semantic node.

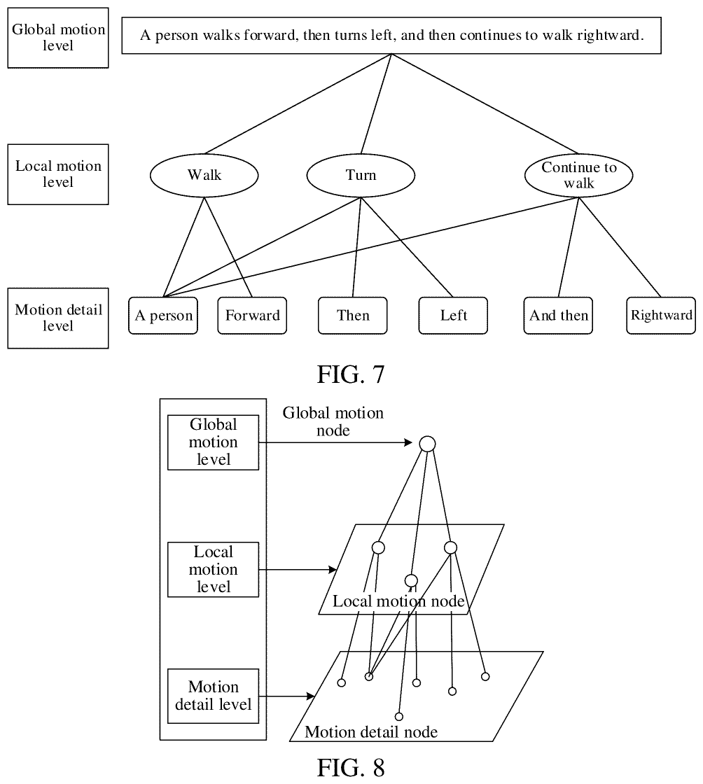

In a specific application, using an example in which the motion description text is “A person walks forward, then turns left, and then continues to walk rightward” and the plurality of semantic levels include the global motion level, the local motion level, and the motion detail level, a constructed hierarchical semantic graph may be shown in FIG. 7. A semantic node “A person walks forward, then turns left, and then continues to walk rightward” of the global motion level is connected to semantic nodes “walk”, “turn”, and “continue to walk” of the local motion level, the semantic node “walk” of the local motion level is connected to semantic nodes “a person” and “forward” of the motion detail level, the semantic node “turn” of the local motion level is connected to semantic nodes “a person”, “then”, and “left” of the motion detail level, and the semantic node “continue to walk” of the local motion level is connected to semantic nodes “a person”, “and then”, and “rightward” of the motion detail level. In a specific application, the constructed hierarchical semantic graph may be simplified as shown in FIG. 8, where the global motion level includes one semantic node (which may also be referred to as a global motion node), the local motion level includes three semantic nodes (which may also be referred to as local motion nodes), and the motion detail level includes six semantic nodes (which may also be referred to as motion detail nodes).

In this embodiment, based on a case in which the semantic nodes are determined, the connection edges connecting the semantic nodes are determined based on the semantic association relationship, and the node representation of each semantic node is determined, the hierarchical semantic graph representing a semantic hierarchical relationship of the motion description text can be constructed by using the semantic nodes, the connection edges connecting the semantic nodes, and the node representation of each semantic node. Further, the node representation of each semantic node in the hierarchical semantic graph may be updated by using the graph attention mechanism, so that the node representations of the semantic nodes fully interact to obtain the updated node representation of each semantic node. Further, the second eigenvector that accurately represents each piece of motion description information is obtained by using the updated node representation of each semantic node.

In an embodiment, the updating the node representation of each semantic node in the hierarchical semantic graph by using a graph attention mechanism includes: determining, for each semantic node in the hierarchical semantic graph, at least one neighboring node of the semantic node; performing graph attention mechanism-based interaction processing on a node representation of the at least one neighboring node and a node representation of the semantic node to determine attention weight coefficients of the at least one neighboring node and the semantic node; and performing weighted summation on the node representation of the at least one neighboring node and the node representation of the semantic node according to the attention weight coefficients to obtain an updated node representation of the semantic node.

The neighboring node is a semantic node that is connected to the semantic node by using a connection edge in the hierarchical semantic graph. For example, in the hierarchical semantic graph shown in FIG. 7, at least one neighboring node of the semantic node “A person walks forward, then turns left, and then continues to walk rightward” of the global motion level is the semantic nodes “walk”, “turn”, and “continue to walk” of the local motion level. At least one neighboring node of the semantic node “walk” of the local motion level is the semantic node “A person walks forward, then turns left, and then continues to walk rightward” of the global motion level and the semantic nodes “a person” and “forward” of the motion detail level. At least one neighboring node of the semantic node “turn” of the local motion level is the semantic node “A person walks forward, then turns left, and then continues to walk rightward” of the global motion level and the semantic nodes “a person”, “then”, and “left” of the motion detail level. At least one neighboring node of the semantic node “continue to walk” of the local motion level is the semantic node “A person walks forward, then turns left, and then continues to walk rightward” of the global motion level and the semantic nodes “a person”, “and then”, and “rightward” of the motion detail level.

Specifically, for each semantic node in the hierarchical semantic graph, the server determines at least one neighboring node of the semantic node based on a connection relationship between the semantic nodes in the hierarchical semantic graph, performs graph attention mechanism-based interaction processing on a node representation of the at least one neighboring node and a node representation of the semantic node, and determines attention weight coefficients of the at least one neighboring node and the semantic node. For each neighboring node in the at least one neighboring node, an attention weight coefficient of the neighboring node indicates importance of a node representation of the neighboring node for the semantic node. Based on this, the server may perform weighted summation on the node representation of the at least one neighboring node and the node representation of the semantic node according to the attention weight coefficients to obtain an updated node representation of the semantic node.

In a specific application, when performing graph attention mechanism-based interaction processing on the node representation of the at least one neighboring node and the node representation of the semantic node, the server may determine the attention weight coefficients of the at least one neighboring node and the semantic node through similarity calculation. To be specific, for each neighboring node in the at least one neighboring node, the server may calculate a node representation similarity between a node representation of the neighboring node and the node representation of the semantic node, and use the node representation similarity as an attention weight coefficient of the neighboring node.

In a specific application, when performing graph attention mechanism-based interaction processing on the node representation of the at least one neighboring node and the node representation of the semantic node, the server may alternatively determine the attention weight coefficients of the at least one neighboring node and the semantic node by first performing linear transformation and then mapping. To be specific, for each neighboring node in the at least one neighboring node, the server first performs linear transformation on a node representation of the neighboring node and the node representation of the semantic node by using a pre-trained linear transformation layer, that is, performs mapping to high-dimensional features, to obtain sufficient expression capabilities; concatenates the two node representations on which the linear transformation has been performed; and then maps the two concatenated node representations to a real number, and uses the real number as an attention weight coefficient of the neighboring node.

In a specific application, in the graph attention mechanism of this embodiment, only a neighboring node is allowed to participate in an attention mechanism for a semantic node, so that structure information of the graph is introduced. To be specific, only the neighboring node of one hop is considered when the graph attention mechanism-based interaction processing is performed. The neighboring node of one hop of the semantic node includes the semantic node, and this may be understood as a self-loop edge.

In a specific application, after the attention weight coefficients of the at least one neighboring node and the semantic node are determined, to make attention weight coefficients of different semantic nodes easier to compare, the server may normalize the attention weight coefficients of the at least one neighboring node and the semantic node, and then perform weighted summation on the node representation of the at least one neighboring node and the node representation of the semantic node by using normalized attention weight coefficients, to obtain the updated node representation of the semantic node.

In an embodiment, the server may alternatively update, by using a pre-trained graph attention network, the node representation of each semantic node in the hierarchical semantic graph by using the graph attention mechanism. The node representation of each semantic node in the hierarchical semantic graph is inputted to the pre-trained graph attention network, and the pre-trained graph attention network may output the updated node representation of each semantic node.

The processing principle used when the pre-trained graph attention network updates the node representation of each semantic node in the hierarchical semantic graph by using the graph attention mechanism is the same as that in the foregoing embodiment, and the processing principles are: For each semantic node in the hierarchical semantic graph, at least one neighboring node of the semantic node is first determined, then graph attention mechanism-based interaction processing is performed on a node representation of the at least one neighboring node and a node representation of the semantic node, attention weight coefficients of the at least one neighboring node and the semantic node are determined, and weighted summation is finally performed on the node representation of the at least one neighboring node and the node representation of the semantic node according to the attention weight coefficients, to obtain an updated node representation of the semantic node.

In this embodiment, for each semantic node in the hierarchical semantic graph, at least one neighboring node of the semantic node is first determined, and then graph attention mechanism-based interaction processing is performed on node representations, to obtain attention weight coefficients of the at least one neighboring node and the semantic node. Further, weighted summation may be performed on the node representation of the at least one neighboring node and the node representation of the semantic node according to the attention weight coefficients, to update the node representation of the semantic node, so that the node representation of the semantic node can be fully fused with the node representation of the neighboring node, to more accurately express the motion description information.

In an embodiment, the virtual object motion generation method further includes: adjusting, when the virtual object motion is obtained and in response to an edge weight adjusting event for the connection edges connecting the semantic nodes in the hierarchical semantic graph, an edge weight of a connection edge indicated by the edge weight adjusting event, to obtain an updated hierarchical semantic graph; updating the node representation of each semantic node in the updated hierarchical semantic graph by using the graph attention mechanism, and obtaining a third eigenvector of each piece of motion description information according to an updated node representation of each semantic node; concatenating, for each semantic level, respective third eigenvectors of at least two pieces of motion description information belonging to the semantic level, and using a concatenated third eigenvector as an updated motion description representation of the semantic level, to obtain respective updated motion description representations of the plurality of semantic levels; and generating an adjusted virtual object motion based on the updated motion description representations of the plurality of semantic levels.

The edge weight adjusting event is an event for adjusting weights of the connection edges connecting the semantic nodes in the hierarchical semantic graph. For example, initial weights of the connection edges connecting semantic nodes in the hierarchical semantic graph are the same, and a weight of at least one of the connection edges may be adjusted by using the edge weight adjusting event, to implement more fine-grained control on the generation of the virtual object motion.

Specifically, when the virtual object motion is obtained, if more fine-grained control on the generation of the virtual object motion needs to be implemented, an interaction object may trigger the edge weight adjusting event for the connection edges connecting the semantic nodes in the hierarchical semantic graph. In response to the edge weight adjusting event, the server adjusts the edge weight of the connection edge indicated by the edge weight adjusting event, to obtain the updated hierarchical semantic graph. After obtaining the updated hierarchical semantic graph, the server updates the node representation of each semantic node in the updated hierarchical semantic graph by using the graph attention mechanism; uses the updated node representation of each semantic node as the third eigenvector of the corresponding motion description information; concatenates, for each semantic level, the third eigenvectors of the at least two pieces of motion description information belonging to the semantic level, and uses the concatenated third eigenvector as the updated motion description representation of the semantic level, to obtain the updated motion description representations of the plurality of semantic levels; and generates the adjusted virtual object motion by using the updated motion description representations of the plurality of semantic levels, to implement the more fine-grained control on the generation of the virtual object motion.

In a specific application, after obtaining the updated motion description representations of the plurality of semantic levels, the server performs denoising processing at the first semantic level on the sampled noise signal based on an updated motion description representation of the first semantic level to obtain an adjusted motion eigenvector outputted by the first semantic level; performs, at each semantic level after the first semantic level, denoising processing on the sampled noise signal based on an adjusted motion eigenvector outputted by a previous semantic level and respective updated motion description representations of at least two semantic levels from the first semantic level to the current semantic level, to obtain an adjusted motion eigenvector that is obtained through cascade denoising; and decodes the adjusted motion eigenvector obtained through the cascade denoising, to obtain the adjusted virtual object motion.

In a specific application, the interaction object may trigger, by using a voice or text, the edge weight adjusting event for the connection edges connecting the semantic nodes in the hierarchical semantic graph. After receiving the voice or text of the interaction object, the server performs identification on the voice or text to identify an adjustment mode for adjusting the edge weights, and then adjusts an edge weight indicated by the adjustment mode. For example, using the example in which the motion description text is “A person walks forward, then turns left, and then continues to walk rightward”, a voice or text for adjusting the edge weights may be “turn left a bit more”. After receiving the voice or text, the server determines that an adjustment mode is “turn left a bit more”, and adjusts an edge weight (namely, a weight of a connection edge connecting two semantic nodes: “turn” and “left”) indicated by the adjustment mode, to increase the edge weight to implement “turn left a bit more”.

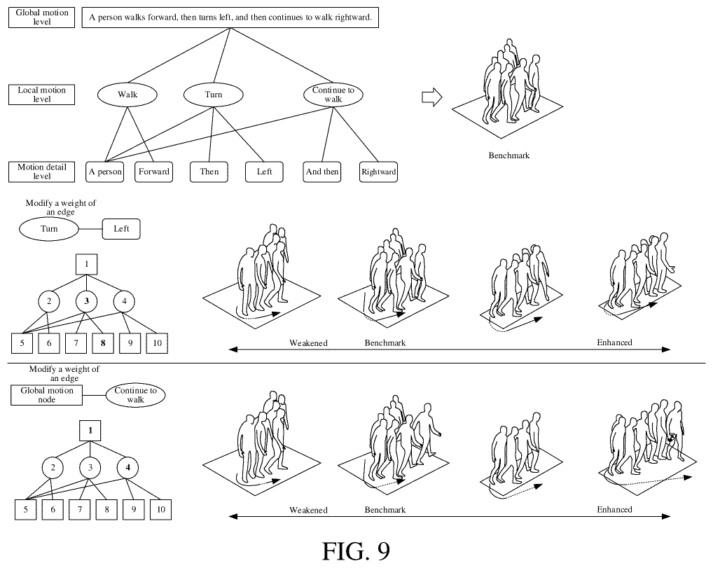

In a specific application, as shown in FIG. 9, using the example in which the motion description text is “A person walks forward, then turns left, and then continues to walk rightward”, a virtual object motion generated as a benchmark based on this is shown in FIG. 9. If a weight of an edge connecting semantic nodes “turn” and “left” (which is a connection edge connecting a semantic node 3 and a semantic node 8 shown in FIG. 9) is increased (that is, enhanced), it may be learned from a comparison between a fine-adjustment result (an adjusted virtual object motion) in FIG. 9 and the virtual object motion as the benchmark that an amplitude of turning left becomes larger. If a weight of an edge connecting semantic nodes “turn” and “left” is decreased (that is, weakened), it may be learned from a comparison between a fine-adjustment result (an adjusted virtual object motion) in FIG. 9 and the virtual object motion as the benchmark that an amplitude of turning left becomes smaller.

In a specific application, if a weight of an edge connecting semantic nodes “A person walks forward, then turns left, and then continues to walk rightward” and “continue to walk” (which is a connection edge connecting a semantic node 1 and a semantic node 4 shown in FIG. 9) is increased (that is, enhanced), it may be learned from a comparison between a fine-adjustment result (an adjusted virtual object motion) in FIG. 9 and the virtual object motion as the benchmark that the motion of “continue to walk” becomes more clear. If a weight of an edge connecting semantic nodes “A person walks forward, then turns left, and then continues to walk rightward” and “continue to walk” is decreased (that is, weakened), it may be learned from a comparison between a fine-adjustment result (an adjusted virtual object motion) in FIG. 9 and the virtual object motion as the benchmark that the motion of “continue to walk” becomes less clear.

In this embodiment, the edge weight of the connection edge in the hierarchical semantic graph can be adjusted to generate an adjusted virtual object. Fine-grained control on the generation of the virtual object is implemented through the edge weight adjustment, so that the generated adjusted virtual object better conforms to a requirement.

In an embodiment, the performing denoising processing at the first semantic level in the plurality of semantic levels on the sampled noise signal based on a motion description representation of the first semantic level, to obtain a motion eigenvector outputted by the first semantic level includes: using the sampled noise signal as a noise signal on which a plurality of noising steps have been performed, performing, from the last step in the plurality of noising steps based on the motion description representation of the first semantic level in the plurality of semantic levels, inverse denoising processing on a noise signal inputted at each step, and using a denoised signal obtained through denoising processing on a noise signal inputted at the first step as the motion eigenvector outputted by the first semantic level.

Specifically, when performing denoising processing at the first semantic level, the server uses the sampled noise signal as the noise signal on which the plurality of noising steps have been performed, performs, from the last step in the plurality of noising steps with reference to the motion description representation of the first semantic level, inverse denoising processing on the noise signal inputted at each step, and uses the denoised signal obtained through denoising on the noise signal inputted at the first step as the motion eigenvector outputted by the first semantic level.

In a specific application, a noise signal inputted at the last step in the plurality of noising steps is the sampled noise signal, and starting from the penultimate step in the plurality of noising steps, a noise signal inputted at each step is a denoised signal outputted after denoising processing is performed at a subsequent step. In addition, the motion description representation of the first semantic level needs to be referenced for each of the plurality of noising steps, noise added at a noising step is predicted based on the motion description representation of the first semantic level and the noising step, and then denoising processing is performed, according to the predicted added noise, on a noise signal inputted at the noising step.

In a specific application, assuming that the plurality of noising steps are T noising steps, T denoising steps need to be performed when the denoising processing is performed on the sampled noise signal. The server uses the sampled noise signal as a noise signal on which the T noising steps have been performed; and performs, from a denoising step T with reference to the motion description representation of the first semantic level, inverse denoising processing on the noise signal inputted at each step, and uses a denoised signal obtained by performing denoising processing on a noise signal inputted at the first step (a denoising step 1) as the motion eigenvector outputted by the first semantic level. During the denoising step T, an inputted noise signal is the sampled noise signal. Starting from a denoising step T−1, a noise signal inputted at each step is a denoised signal outputted after denoising processing is performed at a subsequent step.

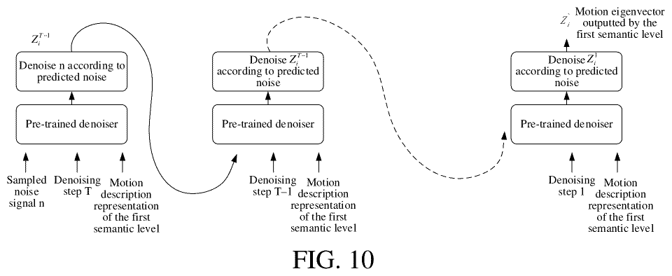

In a specific application, denoising processing performed at each step may be implemented by using a pre-trained denoiser. The pre-trained denoiser may be configured and trained according to an actual application scenario. In this case, a denoising processing process of obtaining the motion eigenvector outputted by the first semantic level may be shown in FIG. 10. For each step in the T noising steps, noise prediction may be performed through the pre-trained denoiser based on the motion description representation of the first semantic level, an inputted noise signal, and the noising step, and denoising processing may be performed on the inputted noise signal by using noise predicted through the pre-trained denoiser, to obtain a denoised signal. After denoising processing on a noise signal inputted at the first step (a denoising step 1) is completed, a denoised signal obtained by performing denoising processing on the noise signal inputted at the first step (the denoising step 1) is used as the motion eigenvector outputted by the first semantic level. In this process, the pre-trained denoiser is used for T times.

As shown in FIG. 10, the server performs, from the last step (a noising step T) in the plurality of noising steps, inverse denoising processing on the inputted noise signal based on the motion description representation of the first semantic level. At the last step in the plurality of noising steps, a noise signal obtained through denoising is

$${z}_{i}^{T - 1} .$$

At the penultimate step (a denoising step T−1) in the plurality of noising steps, an inputted noise signal is the noise signal

$${z}_{i}^{T - 1}$$

obtained through denoising that is outputted at the last step (the noising step T). A denoised signal obtained by performing denoising processing on a noise signal (

$${z}_{i}^{1}$$

shown in FIG. 10) inputted at the first step is the motion eigenvector (zᵢ′ shown in FIG. 10) outputted by the first semantic level.

In this embodiment, the sampled noise signal is used as the noise signal on which the plurality of noising steps are performed, and the inverse denoising processing is performed, from the last step in the plurality of noising steps based on the motion description representation of the first semantic level, on the noise signal inputted at each step, so that accurate denoising can be implemented step by step with reference to the motion description representation of the first semantic level, to obtain the motion eigenvector outputted by the first semantic level.

In an embodiment, for each noising step in the plurality of noising steps, an operation of performing denoising processing on a noise signal inputted at the noising step includes: encoding a step ranking of the noising step to obtain a noising step feature; fusing the motion description representation of the first semantic level and the noising step feature to obtain a denoising condition feature; and performing, according to the denoising condition feature, denoising processing on the noise signal inputted at the noising step, to obtain a denoised signal.

The noising step feature is a feature representing the noising step, and can be used for distinguishing the noising step from other noising steps. The denoising condition feature is a feature used as a guiding condition of the denoising processing. Denoising processing performed for different denoising condition features are not completely the same. For example, for different denoising condition features, added noise that is predicted during denoising processing and that corresponds to noising steps is different.

Specifically, for each step in the plurality of noising steps, when performing denoising processing on the noise signal inputted at the noising step, the server encodes the step ranking of the noising step to obtain the noising step feature, then fuses the motion description representation of the first semantic level and the noising step feature to obtain the denoising condition feature, and finally performs, with reference to the denoising condition feature, denoising processing on the noise signal inputted at the noising step, to obtain the denoised signal.

In a specific application, the server may encode the step ranking of the denoising step by using a pre-trained encoding network. The pre-trained encoding network may be configured according to an actual application scenario. For example, the pre-trained encoding network may be specifically a pre-trained multi-layer perceptron (MLP). The server may fuse the motion description representation of the first semantic level and the noising step feature through concatenation, to obtain the denoising condition feature.

In this embodiment, the step ranking of the noising step is encoded to obtain the noising step feature, and the motion description representation of the first semantic level and the noising step feature are fused to obtain the denoising condition feature, so that the denoising processing is further performed, with reference to the denoising condition feature, on the noise signal inputted at the noising step, to obtain the denoised signal to implement denoising.

In an embodiment, the performing, according to the denoising condition feature, denoising processing on the noise signal inputted at the noising step, to obtain a denoised signal includes: predicting, according to the denoising condition feature and the noise signal inputted at the noising step, added noise corresponding to the noising step, to obtain first predicted added noise corresponding to the noising step; and subtracting the first predicted added noise from the noise signal inputted at the noising step, to perform denoising processing to obtain the denoised signal.

Specifically, the server encodes, based on an attention mechanism, the denoising condition feature and the noise signal inputted at the noising step, to obtain attention encoded vectors respectively corresponding to the denoising condition feature and the noise signal inputted at the noising step; then decodes the attention encoded vectors to obtain the first predicted added noise corresponding to the noising step; and finally subtracts the first predicted added noise from the noise signal inputted at the noising step, to perform denoising processing to obtain the denoised signal.

The attention mechanism is a resource allocation solution for allocating a computing resource to a more important task and resolving an information overload problem when a computing capability is limited. In neural network learning, generally, more parameters of a model indicate a stronger expression capability of the model and a larger amount of information stored by the model. However, this causes the information overload problem. Therefore, by introducing the attention mechanism, information that is more key to a current task is focused on in massive inputted information, attention on other information is reduced, and irrelevant information is even filtered out, so that the information overload problem can be resolved, and task processing efficiency and accuracy can be improved. In this embodiment, information that is more key to the prediction of the first predicted added noise and that is in the denoising condition feature and the noise signal inputted at the noising step is focused on, to improve efficiency and accuracy of the prediction of the first predicted added noise.

In a specific application, the attention mechanism may be a multi-head attention mechanism, and the server may obtain, through a multi-layer encoding and decoding process, the first predicted added noise corresponding to the noising step. In a specific application, the server may predict, by using a pre-trained denoiser, the added noise corresponding to the noising step. The pre-trained denoiser inputs the denoising condition feature and the noise signal inputted at the noising step, and outputs the first predicted added noise corresponding to the noising step. The pre-trained denoiser may be configured and trained according to an actual application scenario. In a specific application, the pre-trained denoiser may be a network based on N1 transformer layers (a transformer network) and N2 attention heads, where N1 and N2 are positive integers and may be configured according to an actual application scenario.

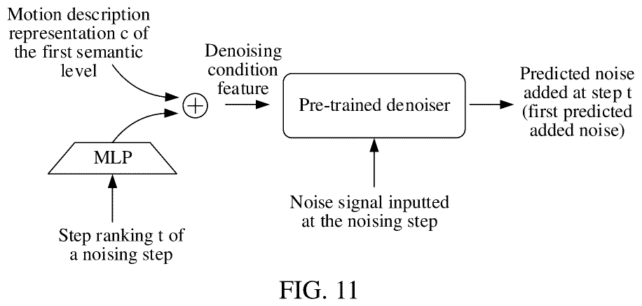

In a specific application, a schematic diagram of predicting added noise corresponding to a noising step may be shown in FIG. 11. The server encodes a step ranking t of the noising step by using the MLP to obtain a noising step feature; concatenates the motion description representation c of the first semantic level and the noising step feature (indicated by ⊕ in FIG. 11) to obtain a denoising condition feature; and inputs the denoising condition feature and a noise signal inputted at the noising step to the pre-trained denoiser, so that the pre-trained denoiser predicts, based on the denoising condition feature and the noise signal inputted at the noising step, the added noise corresponding to the noising step (namely, noise added at step t), to obtain first predicted added noise corresponding to the noising step.

In this embodiment, the first predicted added noise corresponding to the noising step can be obtained by predicting, according to the denoising condition feature and the noise signal inputted at the noising step, the added noise corresponding to the noising step, so that the denoising processing can be directly performed, according to the first predicted added noise, on the noise signal inputted at the noising step, to obtain the denoised signal to implement denoising through noise prediction.

In an embodiment, the virtual object motion is determined by using a pre-trained motion sequence generation model, the motion sequence generation model including a cascade denoising network and a decoder; the cascade denoising network is configured to perform denoising processing at each of the plurality of semantic levels to obtain the motion eigenvector that is obtained through the cascade denoising at the plurality of semantic levels; and the decoder is configured to decode the motion eigenvector obtained through the cascade denoising, to obtain the virtual object motion.

Specifically, the pre-trained motion sequence generation model is a model used for generating the virtual object motion. The motion sequence generation model includes the cascade denoising network and the decoder. The cascade denoising network is configured to perform denoising processing at each of the plurality of semantic levels to obtain the motion eigenvector that is obtained through the cascade denoising at the plurality of semantic levels. The decoder is configured to decode the motion eigenvector obtained through the cascade denoising, to obtain the virtual object motion.

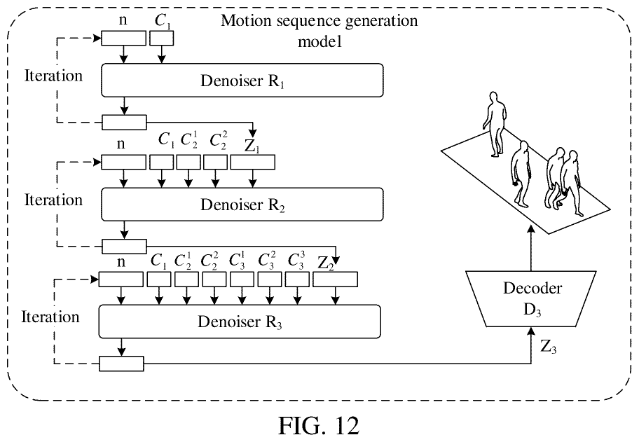

In a specific application, an example in which the cascade denoising network includes three denoisers is used. A structure of the pre-trained motion sequence generation model may be shown in FIG. 12. In the cascade denoising network, inputs of a denoiser of the first semantic level are a sampled noise signal n and a motion description representation C₁ of the first semantic level. After performing a plurality of operations of inverse denoising processing (namely, iteration shown in FIG. 12) on the sampled noise signal n as a noise signal on which a plurality of noising steps have been performed, the denoiser of the first semantic level outputs a motion eigenvector Z₁. At each semantic level after the first semantic level, inputs of a denoiser of the semantic level include the sampled noise signal n, respective motion description representations from the first semantic level to the current semantic level, and a motion eigenvector outputted by a previous semantic level (as shown in FIG. 12, motion description representations inputted at the second semantic level include the motion description representation C₁ of the first semantic level and two motion description representations

$${C}_{2}^{1} and {C}_{2}^{2}$$

of the current semantic level, motion description representations inputted at the third semantic level include the motion description representation C₁ of the first semantic level, the motion description representations

$${C}_{2}^{1} and {C}_{2}^{2}$$

of the second semantic level, and motion description representations

$${C}_{3}^{1} , {C}_{3}^{2} , and {C}_{3}^{3}$$

of the current semantic level, and a motion eigenvector outputted by a denoiser of the second semantic level is Z₂). The denoiser of the semantic level is also configured to perform the plurality of operations of inverse denoising processing (namely, the iteration shown in FIG. 12). A motion eigenvector Z₃ outputted by a denoiser of the third semantic level is the motion eigenvector obtained through the cascade denoising. The motion eigenvector obtained through the cascade denoising that is outputted by the cascade denoising network is an input of a decoder D₃, and the decoder D₃ decodes the motion eigenvector obtained through the cascade denoising, to obtain the virtual object motion.

In this embodiment, the motion sequence generation model including the cascade denoising network and the decoder can be used for implementing accurate reasoning on the virtual object motion, to improve accuracy of the generated virtual object motion.

In an embodiment, the cascade denoising network is obtained through a training operation, and the training operation includes: obtaining a plurality of training samples; and training, for each training sample in the plurality of training samples, an initial denoising network according to sample description text and a motion sequence in the training sample to obtain the cascade denoising network.

The training sample is a sample for training the cascade denoising network. Each training sample includes sample description text and a motion sequence. The sample description text in the training sample is used for describing the motion sequence in the training sample, in other words, the sample description text in the training sample corresponds to the motion sequence. Similar to the motion description text, the sample description text may also include information such as a motion type, a movement path, and a motion style. The motion sequence is a sequence including multiple motions, and the multiple motions correspond to a virtual object motions described in the sample description text. For example, the multiple motions may be specifically at least two motions in a process in which a virtual object walks forward and turns right by one circle. The number of motions in the motion sequence may be configured according to an actual application scenario. The initial denoising network is a denoising network on which parameter training has not been performed. The cascade denoising network may be obtained by training the initial denoising network.

Specifically, the server obtains the plurality of training samples, and trains, for each training sample in the plurality of training samples, the initial denoising network according to the sample description text and the motion sequence in the training sample to obtain the cascade denoising network. In a specific application, the initial denoising network includes a plurality of cascaded initial denoisers. Training the initial denoising network means training the plurality of cascaded initial denoisers, so that the plurality of initial denoisers have a noise prediction capability after being trained. Further, the denoising processing may be performed on the sampled noise signal by using the pre-trained cascade denoising network, to generate the motion eigenvector that is obtained through the cascade denoising.

In this embodiment, the plurality of training samples are obtained, so that the initial denoising network can be trained by using the sample description text and the motion sequence in each training sample, to obtain the cascade denoising network. In this way, the denoising processing may be performed by using the cascade denoising network to implement the accurate reasoning on the virtual object motion and improve the accuracy of the generated virtual object motion.

In an embodiment, the training an initial denoising network according to sample description text and a motion sequence in the training sample to obtain the cascade denoising network includes: parsing the sample description text in the training sample at the plurality of semantic levels through semantic analysis to obtain respective sample description information of the plurality of semantic levels; separately encoding the sample description information of the plurality of semantic levels to obtain respective sample description representations of the plurality of semantic levels; and training the initial denoising network based on the sample description representations of the plurality of semantic levels and the motion sequence in the training sample to obtain the cascade denoising network.

Specifically, the semantic analysis may be specifically semantic role parsing. In this case, the server parses the sample description text in the training sample at the plurality of preset semantic levels through the semantic role parsing, to obtain the sample description information of the plurality of semantic levels; encodes each piece of sample description information of each of the plurality of semantic levels, to obtain a fourth eigenvector of each piece of sample description information; obtains the sample description representations of the plurality of semantic levels based on the fourth eigenvector of each piece of sample description information; and trains the initial denoising network based on the sample description representations of the plurality of semantic levels and the motion sequence in the training sample, to obtain the cascade denoising network. For ease of training and processing, the motion sequence in the targeted training sample may be serialized data.

In a specific application, the server may encode each piece of sample description information of each of the plurality of semantic levels by using a pre-trained natural language model that is used for text feature extraction, to obtain the fourth eigenvector of each piece of sample description information, and concatenate fourth eigenvectors of sample description information of a same semantic level to obtain the sample description representations of the plurality of semantic levels. The pre-trained natural language model that is used for text feature extraction may be trained according to an actual application scenario.

In this embodiment, based on obtaining the sample description representations of the plurality of semantic levels through parsing and encoding at the semantic levels, the initial denoising network can be trained by using the sample description representation and the motion sequence in the training sample to obtain the cascade denoising network, so that the denoising processing can be performed by using the cascade denoising network to implement the accurate reasoning on the virtual object motion and improve the accuracy of the generated virtual object motion.

In an embodiment, the training the initial denoising network based on the sample description representations of the plurality of semantic levels and the motion sequence in the training sample to obtain the cascade denoising network includes: separately performing motion encoding at a plurality of encoding levels on the motion sequence in the training sample to obtain implicit motion representations respectively corresponding to the plurality of semantic levels; and training the initial denoising network based on the sample description representations of the plurality of semantic levels and the implicit motion representations respectively corresponding to the plurality of semantic levels to obtain the cascade denoising network.

Each of the plurality of encoding levels is used for performing motion encoding on the motion sequence in the training sample, and encoding dimensions for motion encoding on the motion sequence at different encoding levels are different. In this manner, implicit motion representations of a plurality of dimensions can be obtained. The implicit motion representation may be understood as an implicit motion encoded vector representing the motion sequence.

Specifically, at each of the plurality of encoding levels, the server learns a motion representation by performing encoding-decoding on the motion sequence in the training sample, to obtain an implicit motion representation of the encoding level. When implicit motion representations of the plurality of encoding levels are obtained, the implicit motion representations of the plurality of encoding levels are respectively used as the implicit motion representations respectively corresponding to the plurality of semantic levels. After obtaining the implicit motion representations respectively corresponding to the plurality of semantic levels, the server trains the initial denoising network by using the sample description representations of the plurality of semantic levels and the implicit motion representations respectively corresponding to the plurality of semantic levels, to obtain the cascade denoising network.

In this embodiment, the motion encoding at the plurality of encoding levels is performed on the motion sequence to obtain the implicit motion representations respectively corresponding to the plurality of semantic levels. Further, the initial denoising network may be trained from the perspective of the plurality of semantic levels by using the implicit motion representations respectively corresponding to the plurality of semantic levels and the sample description representations, to obtain the cascade denoising network that can implement fine-grained denoising.

In an embodiment, the plurality of encoding levels and the plurality of semantic levels are in one-to-one correspondence; encoding dimensions of the plurality of encoding levels are in ascending order from the first encoding level to the last encoding level; and the separately performing motion encoding at a plurality of encoding levels on the motion sequence in the training sample to obtain implicit motion representations respectively corresponding to the plurality of semantic levels includes: separately performing motion encoding at the plurality of encoding levels on the motion sequence in the training sample to obtain respective motion implicit space features of the plurality of encoding levels; and separately decoding the motion implicit space features of the plurality of encoding levels to obtain the implicit motion representations respectively corresponding to the plurality of semantic levels.

The motion implicit space feature is a feature obtained by mapping the motion sequence in the training sample to an implicit space. The implicit space is a representation of compressed data, and is used for learning a data feature to find a pattern and simplifying a data representation. A dimension of data can be reduced by mapping the data to the implicit space. The encoding dimension is a quantity of dimensions for performing motion encoding on the motion sequence at the encoding level. The encoding dimensions of the plurality of encoding levels are in ascending order from the first encoding level to the last encoding level, in other words, the encoding dimensions of the plurality of encoding levels increase encoding level by encoding level. To be specific, an encoding dimension of the first encoding level is the smallest, and an encoding dimension of the last encoding level is the largest.

Specifically, the plurality of encoding levels and the plurality of semantic levels are in one-to-one correspondence, and the encoding dimensions of the plurality of encoding levels are in ascending order from the first encoding level to the last encoding level, that is, feature dimensions of the obtained motion implicit space features are also in ascending order of the encoding levels. For each encoding level in the plurality of encoding levels, the server performs motion encoding on the motion sequence in the training sample according to an encoding dimension of the encoding level to obtain a motion implicit space feature of the encoding level, then decodes the motion implicit space feature of the encoding level to obtain an implicit motion representation corresponding to the encoding level, and uses the implicit motion representation corresponding to the encoding level as an implicit motion representation corresponding to a semantic level corresponding to the encoding level.

In a specific application, the motion sequence may be serialized data, and the motion implicit space feature may be a motion feature data distribution corresponding to the motion sequence. The motion feature data distribution is sampled to obtain a motion feature sampling point corresponding to the motion sequence, and further, the motion feature sampling point may be decoded to obtain the implicit motion representation corresponding to the encoding level.

In a specific application, the obtained motion feature data distribution includes an average value and a variance. On such a basis, the server may obtain a sample point from a standard normal distribution through random sampling, and then obtain, through reparameterization based on the average value, the variance, and the sample point obtained through the random sampling, the motion feature sampling point corresponding to the motion sequence. The principle of the reparameterization is: If z is a random variable following a Gaussian distribution of an average value g(x) and a covariance h(x), z may be represented as z=h(x)ζ+g(x),ζ˜N(0,I), where is the standard normal distribution. Therefore, when the average value and the variance are obtained, and one sampling point is obtained through the random sampling, the motion feature sampling point z corresponding to the motion sequence can be directly obtained.

In a specific application, operations of first encoding, then sampling, and finally decoding in this embodiment may be implemented by using a pre-trained variational autoencoder. For each encoding level in the plurality of encoding levels, the motion sequence in the training sample may be inputted to the pre-trained variational autoencoder, to obtain an implicit motion representation corresponding to the encoding level.

In a specific application, the variational autoencoder may be defined as an autoencoder. Training of the variational autoencoder is normalized to avoid overfitting and ensure that the implicit space has a good attribute of performing a data generation process. Similar to a standard autoencoder, the variational autoencoder is a structure including an encoder and a decoder, and minimizes, through training, a reconstruction error between encoded and decoded data and initial data. However, to introduce some regularization of the implicit space, some modifications are made to an encoding-decoding process in the variational autoencoder: An input is encoded into a probability distribution in the implicit space instead of a single point in the implicit space. A training process of the variational autoencoder is: First, an input is encoded into a distribution in the implicit space. Second, one point in the implicit space is obtained through sampling from the distribution. Third, the sampling point is decoded, and a reconstruction error is calculated. Finally, the reconstruction error is back-propagated through a network.

In this embodiment, the motion encoding at the plurality of encoding levels is performed on the motion sequence to obtain the implicit motion representations respectively corresponding to the plurality of semantic levels, to implement implicit representation on the motion sequence. Further, the initial denoising network may be trained from the perspective of the plurality of semantic levels by using the implicit motion representations respectively corresponding to the plurality of semantic levels and the sample description representations, to obtain the cascade denoising network that can implement the fine-grained denoising.

In an embodiment, the initial denoising network includes a plurality of cascaded initial denoisers, and each initial denoiser corresponds to one semantic level; and the training the initial denoising network based on the sample description representations of the plurality of semantic levels and the implicit motion representations respectively corresponding to the plurality of semantic levels to obtain the cascade denoising network includes: training, for each initial denoiser in the plurality of initial denoisers, the initial denoiser based on respective sample description representations of at least two semantic levels from the first semantic level to a target semantic level corresponding to the initial denoiser and an implicit motion representation corresponding to the target semantic level, to obtain a trained denoiser; and obtaining the cascade denoising network according to trained denoisers respectively corresponding the plurality of initial denoisers.

Specifically, the initial denoising network includes the plurality of cascaded initial denoisers, and each initial denoiser corresponds to one semantic level. During the training of the initial denoising network, for each initial denoiser in the plurality of initial denoisers, the server trains the initial denoiser based on the sample description representations of the at least two semantic levels from the first semantic level to the target semantic level corresponding to the initial denoiser and the implicit motion representation corresponding to the target semantic level, to obtain the trained denoiser; and obtains the cascade denoising network according to trained denoisers respectively corresponding to the plurality of initial denoisers.

In a specific application, during the training of the initial denoiser, the server first performs noising processing on the implicit motion representation corresponding to the target semantic level corresponding to the initial denoiser, and then predicts, by using the initial denoiser and using the sample description representations of the at least two semantic levels from the first semantic level to the target semantic level corresponding to the initial denoiser as a condition, noise added in a noising processing process, to perform parameter adjustment on the initial denoiser by comparing the noise actually added in the noising processing with noise that is added in the noising processing process and that is predicted by the initial denoiser, so that the initial denoiser can implement accurate noise prediction, to implement the accurate noise prediction by using the initial denoiser at a reasoning stage, thereby performing denoising processing by using predicted noise.

In this embodiment, for each initial denoiser in the plurality of initial denoisers, the initial denoiser is trained based on the sample description representations of the at least two semantic levels from the first semantic level to the target semantic level corresponding to the initial denoiser and the implicit motion representation corresponding to the target semantic level, to obtain the trained denoiser. Further, the cascade denoising network may be obtained according to the trained denoisers respectively corresponding to the plurality of initial denoisers.

In an embodiment, the training, for each initial denoiser in the plurality of initial denoisers, the initial denoiser based on respective sample description representations of at least two semantic levels from the first semantic level to a target semantic level corresponding to the initial denoiser and an implicit motion representation corresponding to the target semantic level, to obtain a trained denoiser includes: obtaining a noising step ranking for adding noise, and obtaining a random noise signal through sampling; adding, according to the noising step ranking, the random noise signal to the implicit motion representation corresponding to the target semantic level, to obtain a noise motion representation; inputting the noise motion representation, the noising step ranking, and the sample description representations of the at least two semantic levels from the first semantic level to the target semantic level corresponding to the initial denoiser to the initial denoiser, and predicting the added noise by using the initial denoiser, to obtain second predicted added noise; and performing parameter adjustment on the initial denoiser according to the second predicted added noise to obtain the trained denoiser.

Specifically, for each initial denoiser in the plurality of initial denoisers, during the training of the initial denoiser, the server first obtains the noising step ranking used for adding the noise; obtains the random noise signal through the sampling; adds, step by step according to the noising step ranking, the random noise signal to the implicit motion representation corresponding to the target semantic level, to obtain the noise motion representation; inputs the noise motion representation, the noising step ranking, and the sample description representations of the at least two semantic levels from the first semantic level to the target semantic level corresponding to the initial denoiser to the initial denoiser, to predict the added noise by using the initial denoiser to obtain the second predicted added noise; and finally, performs parameter adjustment on the initial denoiser according to the second predicted added noise to obtain the trained denoiser.

In a specific application, the noising step ranking used for adding noise may be configured according to an actual application scenario. This is not limited herein in this embodiment. A larger noising step ranking indicates that an obtained noise motion representation is closer to a Gaussian distribution. Therefore, the noise motion representation obtained by adding the random noise signal may be considered as Gaussian noise. In this embodiment, this is equivalent to applying, step by step according to the noising step ranking, the sampled random noise signal to the implicit motion representation corresponding to the target semantic level corresponding to the initial denoiser, so that the implicit motion representation is destroyed and becomes complete Gaussian noise, and then a process of restoring the Gaussian noise to the implicit motion representation corresponding to the target semantic level corresponding to the initial denoiser is learned at an inverse stage by using the initial denoiser.

In a specific application, in this embodiment, the training the initial denoiser to obtain the trained denoiser is implemented based on a diffusion model. The diffusion model is a type of generative model that learns noise prediction by using a Markov noising process, to finally convert a Gaussian noise distribution to a target data distribution. Different from other generative networks, the diffusion model is used for applying noise to a sample step by step at a preceding stage until the sample is destroyed and becomes complete Gaussian noise, and then learning a process of restoring the Gaussian noise to the original sample at an inverse stage.

In this embodiment, the sample is the implicit motion representation corresponding to the target semantic level corresponding to the initial denoiser. The applying noise step by step means applying the sampled random noise signal step by step according to the noising step ranking. The Gaussian noise is the noise motion representation. The learning at the inverse stage means inputting the noise motion representation, the noising step ranking, and the sample description representations of the at least two semantic levels from the first semantic level to the target semantic level corresponding to the initial denoiser to the initial denoiser, and predicting the added noise by using the initial denoiser to obtain the second predicted added noise.

In a specific application, the server compares the second predicted added noise and the random noise signal to obtain a noise prediction error. When the noise prediction error is greater than an error threshold, the server performs parameter adjustment on the initial denoiser according to the noise prediction error, and continues training the initial denoiser on which the parameter adjustment has been performed, until a calculated noise prediction error is less than or equal to the error threshold, to obtain the trained denoiser. The error threshold may be configured according to an actual application scenario.

In this embodiment, the noising step ranking used for adding the noise is obtained, and the random noise signal is obtained through the sampling, so that the random noise signal can be added, by using the noising step ranking, to the implicit motion representation corresponding to the target semantic level, to implement a noising process and obtain the noise motion representation; and further, the noise motion representation, the noising step ranking, and the sample description representations of the at least two semantic levels from the first semantic level to the target semantic level corresponding to the initial denoiser may be inputted to the initial denoiser, to predict the added noise by using the initial denoiser to learn the noise prediction and obtain the second predicted added noise, so that the parameter adjustment may be performed on the initial denoiser according to the second predicted added noise to obtain the trained denoiser and implement the training of the initial denoiser.

In an embodiment, the inputting the noise motion representation, the noising step ranking, and the sample description representations of the at least two semantic levels from the first semantic level to the target semantic level corresponding to the initial denoiser to the initial denoiser, and predicting the added noise by using the initial denoiser, to obtain second predicted added noise includes: inputting, when a previous denoiser is connected in series with the initial denoiser, the noise motion representation, the noising step ranking, the sample description representations of the at least two semantic levels from the first semantic level to the target semantic level corresponding to the initial denoiser, and a reconstructed motion representation outputted by the previous denoiser to the initial denoiser, and predicting the added noise by using the initial denoiser, to obtain the second predicted added noise.

Specifically, during the training of the initial denoiser, when the previous denoiser is connected in series with the initial denoiser, the server inputs the noise motion representation, the noising step ranking, the sample description representations of the at least two semantic levels from the first semantic level to the target semantic level corresponding to the initial denoiser, and the reconstructed motion representation outputted by the previous denoiser to the initial denoiser, and predicts the added noise by using the initial denoiser, to obtain the second predicted added noise. In a specific application, the reconstructed motion representation outputted by the previous denoiser is a representation that is reconstructed by the previous denoiser after the previous denoiser predicts added noise based on data inputted to the previous denoiser and performs denoising processing on an inputted noise motion representation based on predicted noise and that corresponds to an implicit motion representation used before noising, namely, a motion representation restored from the noise motion representation by means of noise prediction learning.

In this embodiment, when the previous denoiser is connected in series with the initial denoiser, the noise motion representation, the noising step ranking, the sample description representations of the at least two semantic levels from the first semantic level to the target semantic level corresponding to the initial denoiser, and the reconstructed motion representation outputted by the previous denoiser are inputted to the initial denoiser, and the added noise is predicted by using the initial denoiser, so that the noise prediction can be learned with reference to the reconstructed motion representation outputted by the previous denoiser, accuracy of the noise prediction can be improved, and the second predicted added noise can be obtained.

This disclosure provides a refined and controllable text-driven virtual object (which may be specifically a virtual person) motion generation method based on hierarchical semantics. In the refined and controllable text-driven virtual object motion generation method, a segment of motion description text for a virtual object motion is received as an input, and a corresponding virtual object motion is synthesized according to information such as a motion type, a movement path, and a motion style specified in the motion description text. The virtual object motion may be specifically a 3D virtual object skeleton or grid sequence. In comparison with a conventional method, the inventor considers that in the solution provided in this disclosure, the inputted text is parsed into new control signals, namely, respective motion description information of a plurality of semantic levels, the motion description information of the plurality of semantic levels is used as fine-grained control signals, and respective motion features of the plurality of semantic levels are captured to refine generation of the virtual object motion, to improve accuracy of the generated virtual object motion.

Specifically, the plurality of semantic levels in this disclosure include a global motion level, a local motion level, and a motion detail level. Correspondingly, a text-to-motion generation process is also divided into three semantic levels respectively corresponding to capturing of a global motion, a local motion, and motion details. Compared with the conventional method, the method in this disclosure has better controllability, and can be used for synthesizing a high-quality virtual object motion. The virtual object motion may be specifically a motion sequence.

The inventor considers that current text-driven human movement generation methods may be summarized into two types of methods: a joint encoding-based method and a diffusion model-based method. In the joint encoding-based method, a motion variational autoencoder and a text variational autoencoder are usually learned. Then, in such a method, the text encoder and the motion encoder are restricted to a shared implicit space by using a KL divergence. In the diffusion model-based method, a conditional diffusion model is used for human movement generation, to learn robust probability mapping from a text descriptor to a human movement sequence. The foregoing two methods both rely on a global representation of text, and mapping from the global text representation with a high-level language to a motion sequence is directly learned.

However, in the conventional method, a text feature is automatically and implicitly extracted by directly using a neural network. This may overly emphasize some details in text but ignore other important information, making the network insensitive to a slight change of the inputted text and lack fine-grained controllability. In addition, motion details cannot be desirably generated in the conventional method. A segment of motion text description usually relates to multiple motions and attributes. However, the global text representation extracted by using the existing method usually cannot convey definition and details required for fully understanding the text, and consequently, synthesis of motion details cannot be effectively guided. Moreover, in the existing method, the direct mapping from the global text representation with the high-level language to the motion sequence further hinders generation of the motion details.

Based on this, this disclosure provides a refined and controllable text-driven virtual object motion generation method based on hierarchical semantics. By using a characteristic that motion description text has a hierarchical structure, the motion description text is parsed at a plurality of preset semantic levels through semantic analysis to obtain respective motion description information of the plurality of semantic levels, and the motion description information of the plurality of semantic levels is used as fine-grained signals to perform controllable movement generation. Specifically, the sentence of the motion description text describes global movement including multiple motions, a global motion includes several local motions, and each local motion includes different motion details serving as attributes thereof, for example, a moving direction and a speed of the motion. Such a global-to-local structure facilitates reliable and comprehensive understanding of a motion description, to implement fine-grained control on a virtual object motion.

In an embodiment, the virtual object motion generation method in this disclosure is described by using an example in which fine-grained control is performed on generation of the virtual object motion based on a hierarchical semantic graph constructed by using the motion description information of the plurality of semantic levels, and the plurality of semantic levels include a global motion level, a local motion level, and a motion detail level.

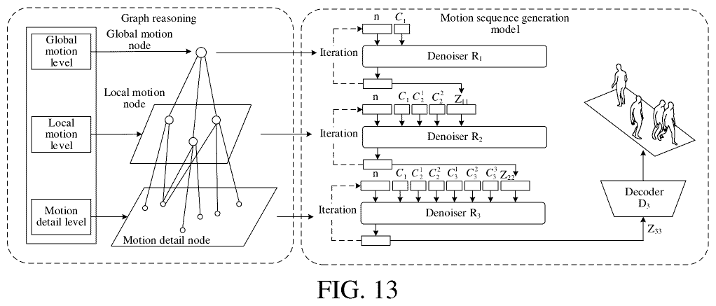

Specifically, an overall framework of the virtual object motion generation method in this disclosure is shown in FIG. 13, and mainly includes two core components: a graph reasoning module and a coarse-to-fine motion sequence generation module. For the motion description text used for describing the virtual object motion, a server extracts, based on a semantic role parsing tool, at least one verb appearing in the motion description text and a verb-modifying phrase respectively corresponding to the at least one verb, and determines a semantic role of each verb-modifying phrase, to obtain the motion description information of the plurality of semantic levels. After obtaining the motion description information of the plurality of semantic levels, the server uses the motion description text as a global motion node of the global motion level in the hierarchical semantic graph, uses the at least one verb as a local motion node of the local motion level in the hierarchical semantic graph, and connects the local motion node to the global motion node by using a direct edge. In addition, the server uses the verb-modifying phrase respectively corresponding to the at least one verb as a motion detail node that is of the motion detail level and that is connected to a corresponding local motion node. Subsequently, the server separately encodes, by using a pre-trained text encoder, the motion description text, the at least one verb, and the verb-modifying phrase respectively corresponding to the at least one verb into node representations of corresponding semantic nodes.

In the graph reasoning module, the server constructs interaction of different levels in the hierarchical semantic graph by using a pre-trained graph attention network, to reduce ambiguity at each semantic node. For example, a verb “pick up” may represent different motions without context, and a verb-modifying phrase “with two hands” eliminates possible ambiguity of the verb. Therefore, the motion should be “pick up with two hands” rather than “pick up with one hand”. Therefore, reasoning is performed on the interaction in the hierarchical semantic graph by using the pre-trained graph attention network, to obtain text representations of three levels, namely, the motion description representations of the plurality of semantic levels, respectively responsible for capturing control information of the global motion, control information of the local motion, and control information of the motion details.

In a specific application, a node representation of each semantic node in the hierarchical semantic graph may be updated by using the graph attention network and a graph attention mechanism. After obtaining an updated node representation of each semantic node, the server uses the updated node representation of each semantic node as a second eigenvector of each piece of motion description information; concatenates, for each semantic level, respective second eigenvectors of at least two pieces of motion description information belonging to the semantic level; and uses a concatenated second eigenvector as a motion description representation of the semantic level to obtain the motion description representations of the plurality of semantic levels.

In the coarse-to-fine motion sequence generation module, a text-to-motion generation process is divided from coarse to fine into three semantic levels that are respectively responsible for capturing the global motion, the local motion, and the motion details.

First, at a training stage, the server first constructs motion encoders of three levels. To be specific, the server trains a motion autoencoder at each of the three semantic levels, and implements motion representation learning through encoding-decoding, to obtain an implicit motion representation z at each semantic level. Using motion representation learning for the global movement as an example, the motion autoencoder includes an encoder E₁ and a decoder D₁, and learns an effective motion representation z₁ by minimizing a reconstruction error of D₁ (E₁ (S₁)), where S₁ is a motion sequence used during training. After performing end-to-end optimization on all components (namely, E₁, . . . , and D₃) of the motion autoencoder, the server freezes all parameters, so that for a motion sequence (which may be specifically 3D human movement) in an inputted training sample, implicit motion representations z₁,z₂,z₃ at three different semantic levels can be obtained.

Subsequently, a hierarchical motion generation module is also designed at the training stage, and the module generates a motion sequence based on a diffusion model. Compared with other generative frameworks, the diffusion model is a generative model based on a random diffusion process in thermodynamics. The process includes a forward process of gradually adding noise to a sample from a data distribution and a backward process of training a neural network to reverse the forward process by gradually removing the noise. In the forward process, a noising process in an implicit space is defined as

$$q ( {z}_{i}^{t} \vert {z}_{i}^{t - 1} ) = N ( \sqrt{{α}^{t}} {z}_{i}^{t - 1} , \sqrt{1 - {α}^{t}} I ) ,$$

where

$${z}_{i}^{t}$$

represents an implicit motion representation of an i^{th} semantic level at noising step t, zᵢ^{t-1} represents an implicit motion representation of the i^{th} semantic level at noising step t−1, and α^{t} is a preconfigured hyper-parameter related to the noising step t, and may be obtained based on the noising step t.

In this embodiment, denoisers R₁,R₂,R₃ at the three semantic levels are connected in series at the training stage. After the training is completed, finest-grained motion implicit encoding, namely, a motion eigenvector obtained through cascade denoising at the plurality of semantic levels, may be obtained from coarse to fine through the trained denoisers R₁,R₂,R₃ connected in series at the three semantic levels and by using a sampled noise signal used for generating the virtual object motion and the motion description text used for describing the virtual object motion.

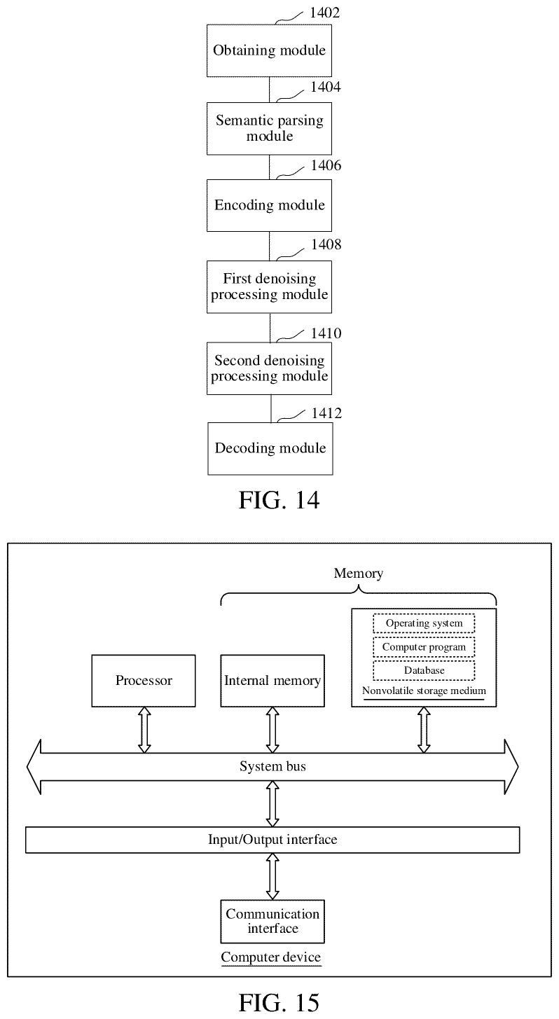

In a specific application, at the global motion level, only a feature of the global motion node (namely, a motion description representation C₁ of the global motion level) is used at an application stage as conditional encoding for the diffusion model to generate a coarse-grained motion eigenvector Z₁₁. The feature of the global motion node (namely, the motion description representation C₁ of the global motion level), a feature of the local motion node (namely, motion description representations C₂¹ and C₂² of the local motion level), and Z₁₁ are jointly used at the local motion level as conditional encoding for the diffusion model to further generate implicit motion encoding Z₂₂. Features of all nodes in the hierarchical semantic graph (as shown in FIG. 14, the motion description representation of the global motion level is C₁, the motion description representations of the local motion level are

$${C}_{2}^{1} and {C}_{2}^{2} ,$$

and motion description representations of the motion detail level are

$${C}_{3}^{1} , {C}_{3}^{2} , and {C}_{3}^{3} )$$

and Z₂₂ are jointly used at the motion detail level as conditional encoding for the diffusion model to generate fine-grained implicit motion encoding Z₃₃. Finally, a decoder D₃ converts Z₃₃ from an implicit feature space back to an original 3D virtual object pose space, to generate a corresponding virtual object movement sequence from a given segment of text description (namely, the motion description text). The virtual object motion may be specifically a 3D human motion sequence.

In an embodiment, Table 1 and Table 2 respectively provide quantitative experimental results of this disclosure on HumanML3D and KIT-ML datasets, where best results all appear in the method of this disclosure. Methods in Table 1 and Table 2 compared with the method of this disclosure include: Real motion, Seq2Seq (sequence to sequence), Language2Pose (joint language and pose), Text2Gesture (text-gesture), Hier (multi-layer attention model), MoCoGAN (model used for video generation), Dance2Music (dance-music model), TM2T (model for generating human movement), T2M (text generation animation), MDM (human motion diffusion model), MLD (motion latent diffusion), and the like.

Currently, five evaluation indicators are widely used in a cross-modal generation task: R-Precision (reflecting text-motion matching precision in retrieval), Frechet Inception Distance (FID, a metric used for calculating a distance between eigenvectors of a real image and a generated image), Multi-Modal Distance (MM Dist), Diversity (defined as a variance of motion eigenvectors of a generated motion in all text descriptions, and reflecting diversity of the motion synthesized by a group of different descriptions), and Multi-modality (MModality, for measuring, by using multiple modes, diversity of a motion generated in each text description, and reflecting diversity of the motion synthesized by the specific description).

Among the five quantitative indicators, R-Precision, FID, and MM Dist mainly reflect vividness of a generated 3D human motion compared with a real motion. Diversity and MModality mainly reflect a diversification degree of the generated 3D human motion. The results in Table 1 and Table 2 show that this disclosure surpasses the existing methods in terms of vividness and diversity of generation results on two major mainstream datasets, and achieves best performance.

TABLE 1
Quantitative comparison of different methods on the HumanML3D dataset

| | R-Precision | | | | MM- | | |
|---|---|---|---|---|---|---|---|
| Methods | Top-1 | Top-2 | Top-3 | FID | Dist | Diversity | MModality |
| Real motion | 0.511 | 0.703 | 0.797 | 0.002 | 2.974 | 9.503 | — |
| Seq2Seq | 0.180 | 0.300 | 0.396 | 11.75 | 5.529 | 6.223 | — |
| Language2Pose | 0.246 | 0.387 | 0.486 | 11.02 | 5.296 | 7.676 | — |
| Text2Gesture | 0.165 | 0.267 | 0.345 | 5.012 | 6.030 | 6.409 | — |
| Hier | 0.301 | 0.425 | 0.552 | 6.532 | 5.012 | 8.332 | — |
| MOCOGAN | 0.037 | 0.072 | 0.106 | 94.41 | 9.643 | 0.462 | 0.019 |
| Dance2Music | 0.033 | 0.065 | 0.097 | 66.98 | 8.116 | 0.725 | 0.043 |
| TM2T | 0.424 | 0.618 | 0.729 | 1.501 | 3.467 | 8.589 | 2.424 |
| T2M | 0.457 | 0.639 | 0.740 | 1.067 | 3.340 | 9.188 | 2.090 |
| MDM | 0.320 | 0.498 | 0.611 | 0.544 | 5.566 | 9.559 | 2.799 |
| MLD | 0.481 | 0.673 | 0.772 | 0.473 | 3.196 | 9.724 | 2.413 |
| This disclosure | 0.504 | 0.699 | 0.785 | 0.116 | 3.070 | 9.692 | 2.766 |

TABLE 2
Quantitative comparison of different methods on the KIT-ML dataset

| | R-Precision | | | | MM- | | |
|---|---|---|---|---|---|---|---|
| Methods | Top-1 | Top-2 | Top-3 | FID | Dist | Diversity | MModality |
| Real motion | 0.424 | 0.649 | 0.779 | 0.031 | 2.788 | 11.08 | — |
| Seq2Seq | 0.103 | 0.178 | 0.241 | 24.86 | 7.960 | 6.744 | — |
| Language2Pose | 0.221 | 0.373 | 0.483 | 6.545 | 5.147 | 9.073 | — |
| Text2Gesture | 0.156 | 0.255 | 0.338 | 12.12 | 6.964 | 9.334 | — |
| Hier | 0.255 | 0.432 | 0.531 | 5.203 | 4.986 | 9.563 | — |
| MOCOGAN | 0.022 | 0.042 | 0.063 | 82.69 | 10.47 | 3.091 | 0.250 |
| Dance2Music | 0.031 | 0.058 | 0.086 | 115.4 | 10.40 | 0.241 | 0.062 |
| TM2T | 0.280 | 0.463 | 0.587 | 3.599 | 4.591 | 9.473 | 3.292 |
| T2M | 0.361 | 0.559 | 0.681 | 3.022 | 3.488 | 10.72 | 2.052 |
| MDM | 0.164 | 0.291 | 0.396 | 0.497 | 9.191 | 10.85 | 1.907 |
| MLD | 0.390 | 0.609 | 0.734 | 0.404 | 3.204 | 10.80 | 2.192 |
| This disclosure | 0.429 | 0.648 | 0.769 | 0.313 | 3.076 | 11.12 | 3.627 |

The inventor considers that, compared with a conventional method, the solution of this disclosure has two significant advantages. First, explicit decomposition and representation in a semantic space enable the solution of this disclosure to establish a fine-grained correspondence between text data and a motion sequence, thereby avoiding imbalanced learning of different text components and coarse-grained control signal representation. Second, hierarchically refined motion sequence generation enhances a generated result from coarse to fine step by step, avoiding an excessively coarse granularity of the generated result, and diversified representation of the result is improved while model generation quality is ensured.

In an embodiment, to further fine-tune the generated virtual object motion to implement more fine-grained control, in the solution of this disclosure, the generated virtual object motion may further be continuously improved by modifying an edge weight of the hierarchical semantic graph, to generate a virtual object motion that better conforms to a requirement.

Specifically, when the virtual object motion is obtained, the server adjusts, in response to an edge weight adjusting event for connection edges connecting the semantic nodes in the hierarchical semantic graph, an edge weight of a connection edge indicated by the edge weight adjusting event, to obtain an updated hierarchical semantic graph; updates the node representation of each semantic node in the updated hierarchical semantic graph by using a graph attention mechanism; obtains a third eigenvector of each piece of motion description information according to an updated node representation of each semantic node; concatenates, for each semantic level, third eigenvectors of at least two pieces of motion description information belonging to the semantic level, and uses a concatenated third eigenvector as an updated motion description representation of the semantic level to obtain respective updated motion description representations of the plurality of semantic levels; and generates an adjusted virtual object motion based on the updated motion description representations of the plurality of semantic levels.

Although the various steps in the flowcharts involved in the embodiments described above are shown in sequence as indicated by the arrows, these steps are not necessarily performed in the sequence indicated by the arrows. Unless otherwise explicitly specified in this disclosure, an execution sequence of the steps is not strictly limited, and the steps may be performed in other sequences. Moreover, at least some of the steps in the flowcharts involved in the embodiments described above may include multiple steps or multiple stages. These steps or stages are not necessarily performed at the same time, but may be performed at different times. These steps or stages are not necessarily performed in sequence, but may be performed in turn or in alternation with other steps or at least some of the steps or stages in other steps.

Based on the same inventive concept, an embodiment of this disclosure further provides a virtual object motion generation apparatus configured to implement the foregoing virtual object motion generation method. A problem-solving implementation scheme provided by the apparatus is similar to the implementation scheme described in the foregoing method. Therefore, for a specific definition in one or more embodiments of the virtual object motion generation apparatus provided below, refer to the definition of the virtual object motion generation method above, and details are not described herein again.

In an embodiment, as shown in FIG. 14, a virtual object motion generation apparatus is provided, including: an obtaining module 1402, a semantic parsing module 1404, an encoding module 1406, a first denoising processing module 1408, a second denoising processing module 1410, and a decoding module 1412.

The term “module” (and other similar terms such as unit, submodule, etc.) refers to computing software, firmware, hardware, and/or various combinations thereof. At a minimum, however, modules are not to be interpreted as software that is not implemented on hardware, firmware, or recorded on a non-transitory processor readable recordable storage medium. Indeed “module” is to be interpreted to include at least some physical, non-transitory hardware such as a part of a processor, circuitry, or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices. The modules can be implemented in software stored in memory or non-transitory computer-readable medium. The software stored in the memory or medium can run on a processor or circuitry (e.g., ASIC, PLA, DSP, FPGA, or any other integrated circuit) capable of executing computer instructions or computer code. The modules can also be implemented in hardware using processors or circuitry on the same or different integrated circuit.

The obtaining module 1402 is configured to obtain motion description text for describing a virtual object motion.

The semantic parsing module 1404 is configured to: parse the motion description text at a plurality of preset semantic levels through semantic analysis to obtain respective motion description information of the plurality of semantic levels, and obtain a sampled noise signal for generating the virtual object motion.

The encoding module 1406 is configured to separately encode the motion description information of the plurality of semantic levels to obtain respective motion description representations of the plurality of semantic levels.

The first denoising processing module 1408 is configured to perform denoising processing at the first semantic level in the plurality of semantic levels on the sampled noise signal based on a motion description representation of the first semantic level, to obtain a motion eigenvector outputted by the first semantic level.

The second denoising processing module 1410 is configured to perform, at each semantic level after the first semantic level in the plurality of semantic levels, denoising processing on the sampled noise signal based on a motion eigenvector outputted by a previous semantic level and respective motion description representations of at least two semantic levels from the first semantic level to the current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level.

The decoding module 1412 is configured to decode the motion eigenvector obtained through the cascade denoising, to obtain the virtual object motion.

According to the foregoing virtual object motion generation apparatus, the motion description text for describing the virtual object motion is obtained; the motion description text is parsed at the plurality of preset semantic levels through the semantic analysis to obtain the motion description information of the plurality of semantic levels, and the sampled noise signal for generating the virtual object motion is obtained; the motion description information of the plurality of semantic levels is separately encoded to obtain the motion description representations of the plurality of semantic levels; the denoising processing at the first semantic level in the plurality of semantic levels is performed on the sampled noise signal based on the motion description representation of the first semantic level, to obtain the motion eigenvector outputted by the first semantic level; and the denoising processing is performed on the sampled noise signal at each semantic level after the first semantic level in the plurality of semantic levels by using the motion eigenvector outputted by the previous semantic level and the motion description representations of the at least two semantic levels from the first semantic level to the current semantic level as a joint condition, so that fine-grained motion details can be gradually enriched by using the motion description representations of the plurality of semantic levels, to obtain a more fine-grained motion eigenvector that accurately represents the virtual object motion and that is obtained through the cascade denoising at the plurality of semantic levels. Further, the motion eigenvector obtained through the cascade denoising may be decoded, to obtain the virtual object motion. In the entire process, the motion description information of the plurality of semantic levels can be used as fine-grained control signals, and motion features of the plurality of semantic levels are captured to refine the generation of the virtual object motion, to improve accuracy of the generated virtual object motion.

In an embodiment, the plurality of semantic levels include a global motion level, a local motion level, and a motion detail level. The semantic parsing module is further configured to: use the motion description text as motion description information of the global motion level; extract, from the motion description text, at least one verb and a verb-modifying phrase respectively corresponding to the at least one verb; use the at least one verb as motion description information of the local motion level; and use the verb-modifying phrase respectively corresponding to the at least one verb as motion description information of the motion detail level.

In an embodiment, the encoding module is further configured to: encode each piece of motion description information of each of the plurality of semantic levels to obtain a first eigenvector of each piece of motion description information; perform, based on a semantic association relationship between at least one pair of motion description information of different semantic levels, attention mechanism-based update processing on the first eigenvector of each piece of motion description information, to obtain a second eigenvector of each piece of motion description information; concatenate, for each semantic level, respective second eigenvectors of at least two pieces of motion description information belonging to the semantic level; and use a concatenated second eigenvector as a motion description representation of the semantic level, to obtain the motion description representations of the plurality of semantic levels.

In an embodiment, the encoding module is further configured to: use each piece of motion description information as a semantic node, and connect, based on the semantic association relationship between at least one pair of motion description information of different semantic levels, two semantic nodes representing a pair of motion description information in the semantic association relationship, to determine connection edges connecting the semantic nodes; use the first eigenvector of each piece of motion description information as a node representation of each semantic node; construct a hierarchical semantic graph according to each semantic node, the connection edges connecting the semantic nodes, and the node representation of each semantic node; and update the node representation of each semantic node in the hierarchical semantic graph by using a graph attention mechanism, and obtain the second eigenvector of each piece of motion description information according to an updated node representation of each semantic node.

In an embodiment, the encoding module is further configured to: determine, for each semantic node in the hierarchical semantic graph, at least one neighboring node of the semantic node; perform graph attention mechanism-based interaction processing on a node representation of the at least one neighboring node and a node representation of the semantic node, to determine attention weight coefficients of the at least one neighboring node and the semantic node; and perform weighted summation on the node representation of the at least one neighboring node and the node representation of the semantic node according to the attention weight coefficients to obtain an updated node representation of the semantic node.

In an embodiment, the virtual object motion generation apparatus further includes an adjustment module. The adjustment module is configured to: adjust, when the virtual object motion is obtained and in response to an edge weight adjusting event for the connection edges connecting the semantic nodes in the hierarchical semantic graph, an edge weight of a connection edge indicated by the edge weight adjusting event, to obtain an updated hierarchical semantic graph; update the node representation of each semantic node in the updated hierarchical semantic graph by using the graph attention mechanism, and obtain a third eigenvector of each piece of motion description information according to an updated node representation of each semantic node; concatenate, for each semantic level, respective third eigenvectors of at least two pieces of motion description information belonging to the semantic level, and use a concatenated third eigenvector as an updated motion description representation of the semantic level, to obtain respective updated motion description representations of the plurality of semantic levels; and generate an adjusted virtual object motion based on the updated motion description representations of the plurality of semantic levels.

In an embodiment, the first denoising processing module is further configured to: use the sampled noise signal as a noise signal on which a plurality of noising steps have been performed; perform, from the last step in the plurality of noising steps based on the motion description representation of the first semantic level in the plurality of semantic levels, inverse denoising processing on a noise signal inputted at each step; and use a denoised signal obtained through denoising on a noise signal inputted at the first step as the motion eigenvector outputted by the first semantic level.

In an embodiment, the first denoising processing module is configured to: encode a step ranking of the noising step to obtain a noising step feature; fuse the motion description representation of the first semantic level and the noising step feature to obtain a denoising condition feature; and perform, according to the denoising condition feature, denoising processing on the noise signal inputted at the noising step, to obtain a denoised signal.

In an embodiment, the first denoising processing module is configured to: predict, according to the denoising condition feature and the noise signal inputted at the noising step, added noise corresponding to the noising step, to obtain first predicted added noise corresponding to the noising step; and subtract the first predicted added noise from the noise signal inputted at the noising step, to perform denoising processing to obtain the denoised signal.

In an embodiment, the virtual object motion is determined by using a pre-trained motion sequence generation model, the motion sequence generation model including a cascade denoising network and a decoder; the cascade denoising network is configured to perform denoising processing at each of the plurality of semantic levels to obtain the motion eigenvector that is obtained through the cascade denoising at the plurality of semantic levels; and the decoder is configured to decode the motion eigenvector obtained through the cascade denoising, to obtain the virtual object motion.

In an embodiment, the virtual object motion generation apparatus further includes a training module. The training module is configured to: obtain a plurality of training samples; and train, for each training sample in the plurality of training samples, an initial denoising network according to sample description text and a motion sequence in the training sample to obtain the cascade denoising network.

In an embodiment, the training module is further configured to: parse the sample description text in the training sample at the plurality of semantic levels through semantic analysis to obtain respective sample description information of the plurality of semantic levels; separately encode the sample description information of the plurality of semantic levels to obtain respective sample description representations of the plurality of semantic levels; and train the initial denoising network based on the sample description representations of the plurality of semantic levels and the motion sequence in the training sample to obtain the cascade denoising network.

In an embodiment, the training module is further configured to: separately perform motion encoding at a plurality of encoding levels on the motion sequence in the training sample to obtain implicit motion representations respectively corresponding to the plurality of semantic levels; and train the initial denoising network based on the sample description representations of the plurality of semantic levels and the implicit motion representations respectively corresponding to the plurality of semantic levels to obtain the cascade denoising network.

In an embodiment, the plurality of encoding levels and the plurality of semantic levels are in one-to-one correspondence; encoding dimensions of the plurality of encoding levels are in ascending order from the first encoding level to the last encoding level; and the training module is further configured to: separately perform motion encoding at the plurality of encoding levels on the motion sequence in the training sample to obtain respective motion implicit space features of the plurality of encoding levels; and separately decode the motion implicit space features of the plurality of encoding levels to obtain the implicit motion representations respectively corresponding to the plurality of semantic levels.

In an embodiment, the initial denoising network includes a plurality of cascaded initial denoisers, and each initial denoiser corresponds to one semantic level; and the training module is further configured to: train, for each initial denoiser in the plurality of initial denoisers, the initial denoiser based on respective sample description representations of at least two semantic levels from the first semantic level to a target semantic level corresponding to the initial denoiser and an implicit motion representation corresponding to the target semantic level, to obtain a trained denoiser; and obtain the cascade denoising network according to trained denoisers respectively corresponding the plurality of initial denoisers.

In an embodiment, the training module is further configured to: obtain a noising step ranking for adding noise, and obtain a random noise signal through sampling; add, according to the noising step ranking, the random noise signal to the implicit motion representation corresponding to the target semantic level, to obtain a noise motion representation; input the noise motion representation, the noising step ranking, and the sample description representations of the at least two semantic levels from the first semantic level to the target semantic level corresponding to the initial denoiser to the initial denoiser, and predict the added noise by using the initial denoiser, to obtain second predicted added noise; and perform parameter adjustment on the initial denoiser according to the second predicted added noise to obtain the trained denoiser.

In an embodiment, the training module is further configured to: input, when a previous denoiser is connected in series with the initial denoiser, the noise motion representation, the noising step ranking, the sample description representations of the at least two semantic levels from the first semantic level to the target semantic level corresponding to the initial denoiser, and a reconstructed motion representation outputted by the previous denoiser to the initial denoiser; and predict the added noise by using the initial denoiser, to obtain the second predicted added noise.

All or some of the modules in the foregoing virtual object motion generation apparatus may be implemented by software, hardware, and a combination thereof. The modules may be built in or independent of a processor in a computer device in a form of hardware, or may be stored in a memory in a computer device in a form of software, so that a processor invokes and executes operations corresponding to the modules.

In an embodiment, a computer device is provided. The computer device may be a server or a terminal. Using an example in which the computer device is the server, an internal structure diagram thereof may be shown in FIG. 15. The computer device includes a processor, a memory, an input/output (referred to as I/O for short) interface, and a communication interface. The processor, the memory, and the input/output interface are connected to each other by using a system bus, and the communication interface is connected to the system bus by using the input/output interface. The processor of the computer device is configured to provide calculation and control capabilities. The memory of the computer device includes a nonvolatile storage medium and an internal memory. The nonvolatile storage medium stores an operating system, a computer program, and a database. The internal memory provides an environment for running of the operating system and the computer program in the nonvolatile storage medium. The database of the computer device is configured to store data such as training samples. The input/output interface of the computer device is configured to exchange information between the processor and an external device. The communication interface of the computer device is configured to be connected to and communicate with an external terminal via a network. The computer program, when executed by the processor, implements a virtual object motion generation method.

A person skilled in the art may understand that, the structure shown in FIG. 15 is merely a block diagram of a part of a structure related to the solution of this disclosure and does not limit the computer device to which the solution of this disclosure is applied. Specifically, the computer device may include more or fewer components than those in the drawings, some components may be combined, or a different component deployment may be used.

In an embodiment, a computer device is further provided, including a memory and a processor. The memory stores a computer program, and the processor, when executing the computer program, performs the operations in the foregoing method embodiments.

In an embodiment, a computer-readable storage medium is provided, having a computer program stored therein. The computer program, when executed by a processor, implements the operations in the foregoing method embodiments.

In an embodiment, a computer program product is provided, including a computer program. The computer program, when executed by a processor, implements the operations in the foregoing method embodiments.

A person of ordinary skill in the art may understand that all or some of procedures of the methods in the foregoing embodiments may be implemented by a computer program instructing relevant hardware. The computer program may be stored in a nonvolatile computer-readable storage medium. When the computer program is executed, the procedures of the foregoing method embodiments may be implemented. Any reference to the memory, the database, or other media used in the embodiments provided in this disclosure may include at least one of a nonvolatile memory and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magneto resistive random access memory (MRAM), a ferroelectric random access memory (FRAM), a phase change memory (PCM), a graphene memory, or the like. The volatile memory may include a random access memory (RAM) an external cache, or the like. For the purpose of illustration but not limitation, the RAM is available in many forms, for example, a static random access memory (SRAM) or a dynamic random access memory (DRAM). The databases involved in various embodiments provided in this disclosure may include at least one of a relational database and a non-relational database. The non-relational database may include a blockchain-based distributed database or the like, but is not limited thereto. The processors involved in various embodiments provided in this disclosure may be a general-purpose processor, a central processing unit, a graphics processor, a digital signal processor, a programmable logic device, a data processing logic device based on quantum computing, or the like, but are not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope set forth in this specification provided that no conflict exists.

The foregoing embodiments show only several implementations of this disclosure and are described in detail, but are not to be construed as a limitation to the patent scope of this disclosure. For a person of ordinary skill in the art, several transformations and improvements can be made without departing from the idea of this disclosure. These transformations and improvements belong to the protection scope of this disclosure. Therefore, the protection scope of this disclosure shall be subject to the appended claims.

What is claimed is:

1. A virtual object motion generation method, performed by a computer device, and comprising:
obtaining motion description text for describing a virtual object motion;
parsing the motion description text at a plurality of preset semantic levels through semantic analysis to obtain respective motion description information of the plurality of semantic levels, and obtaining a sampled noise signal for generating the virtual object motion;
separately encoding the motion description information of the plurality of semantic levels to obtain respective motion description representations of the plurality of semantic levels;
performing denoising processing at a first semantic level in the plurality of semantic levels on the sampled noise signal based on a motion description representation of the first semantic level, to obtain a motion eigenvector outputted by the first semantic level;
performing, at each semantic level after the first semantic level in the plurality of semantic levels, denoising processing on the sampled noise signal based on a motion eigenvector outputted by a previous semantic level and respective motion description representations of at least two semantic levels from the first semantic level to a current semantic level, to obtain a motion eigenvector through cascade denoising at the plurality of semantic levels,
motion granularities represented by motion eigenvectors outputted through denoising processing at the plurality of semantic levels being in descending order from a highest semantic level to a lowest semantic level; and
decoding the motion eigenvector obtained through the cascade denoising, to obtain the virtual object motion.

2. The method according to claim 1, wherein the plurality of semantic levels comprise a global motion level, a local motion level, and a motion detail level, and the parsing the motion description text at a plurality of preset semantic levels through semantic analysis to obtain respective motion description information of the plurality of semantic levels comprises:
using the motion description text as motion description information of the global motion level, and extracting, from the motion description text, at least one verb and a verb-modifying phrase respectively corresponding to the at least one verb; and
using the at least one verb as motion description information of the local motion level, and the verb-modifying phrase respectively corresponding to the at least one verb as motion description information of the motion detail level.

3. The method according to claim 1, wherein the separately encoding the motion description information of the plurality of semantic levels to obtain respective motion description representations of the plurality of semantic levels comprises:
encoding each piece of motion description information of each of the plurality of semantic levels to obtain a first eigenvector of each piece of motion description information;
performing, based on a semantic association relationship between at least one pair of motion description information of different semantic levels, attention mechanism-based update processing on the first eigenvector of each piece of motion description information, to obtain a second eigenvector of each piece of motion description information; and
concatenating, for each semantic level, respective second eigenvectors of at least two pieces of motion description information belonging to the semantic level, and using a concatenated second eigenvector as a motion description representation of the semantic level, to obtain the motion description representations of the plurality of semantic levels.

4. The method according to claim 3, wherein the performing attention mechanism-based update processing on the first eigenvector of each piece of motion description information to obtain the second eigenvector of each piece of motion description information comprises:
using each piece of motion description information as a semantic node, and connecting, based on the semantic association relationship between at least one pair of motion description information of different semantic levels, two semantic nodes representing a pair of motion description information in the semantic association relationship, to determine connection edges connecting the semantic nodes;
using the first eigenvector of each piece of motion description information as a node representation of each semantic node;
constructing a hierarchical semantic graph according to each semantic node, the connection edges connecting the semantic nodes, and the node representation of each semantic node; and
updating the node representation of each semantic node in the hierarchical semantic graph using a graph attention mechanism, and obtaining the second eigenvector of each piece of motion description information according to an updated node representation of each semantic node.

5. The method according to claim 4, wherein the updating the node representation of each semantic node in the hierarchical semantic graph using the graph attention mechanism comprises:
determining, for each semantic node in the hierarchical semantic graph, at least one neighboring node of the semantic node;
performing graph attention mechanism-based interaction processing on a node representation of the at least one neighboring node and a node representation of the semantic node to determine attention weight coefficients of the at least one neighboring node and the semantic node; and
performing weighted summation on the node representation of the at least one neighboring node and the node representation of the semantic node according to the attention weight coefficients to obtain an updated node representation of the semantic node.

6. The method according to claim 4, wherein the method further comprises:
adjusting, in response to the virtual object motion being obtained and an edge weight adjusting event for the connection edges connecting the semantic nodes in the hierarchical semantic graph, an edge weight of a connection edge indicated by the edge weight adjusting event, to obtain an updated hierarchical semantic graph;
updating the node representation of each semantic node in the updated hierarchical semantic graph using the graph attention mechanism, and obtaining a third eigenvector of each piece of motion description information according to an updated node representation of each semantic node;
concatenating, for each semantic level, respective third eigenvectors of at least two pieces of motion description information belonging to the semantic level, and using a concatenated third eigenvector as an updated motion description representation of the semantic level, to obtain respective updated motion description representations of the plurality of semantic levels; and
generating an adjusted virtual object motion based on the updated motion description representations of the plurality of semantic levels.

7. The method according to claim 1, wherein the performing denoising processing at the first semantic level in the plurality of semantic levels on the sampled noise signal based on the motion description representation of the first semantic level comprises:
using the sampled noise signal as a noise signal on which a plurality of noising steps have been performed, performing, from the last step in the plurality of noising steps based on the motion description representation of the first semantic level in the plurality of semantic levels, inverse denoising processing on a noise signal inputted at each step, and using a denoised signal obtained through denoising processing on a noise signal inputted at the first step as the motion eigenvector outputted by the first semantic level.

8. The method according to claim 7, wherein for each noising step in the plurality of noising steps, an operation of performing denoising processing on a noise signal inputted at the noising step comprises:
encoding a step ranking of the noising step to obtain a noising step feature;
fusing the motion description representation of the first semantic level and the noising step feature to obtain a denoising condition feature; and
performing, according to the denoising condition feature, denoising processing on the noise signal inputted at the noising step, to obtain a denoised signal.

9. The method according to claim 8, wherein the performing denoising processing on the noise signal inputted at the noising step comprises:
predicting, according to the denoising condition feature and the noise signal inputted at the noising step, added noise corresponding to the noising step, to obtain first predicted added noise corresponding to the noising step; and
subtracting the first predicted added noise from the noise signal inputted at the noising step, to perform denoising processing to obtain the denoised signal.

10. The method according to claim 1, wherein the virtual object motion is determined using a pre-trained motion sequence generation model, the motion sequence generation model comprises a cascade denoising network and a decoder, the cascade denoising network is configured to perform denoising processing at each of the plurality of semantic levels to obtain the motion eigenvector through the cascade denoising at the plurality of semantic levels, and the decoder is configured to decode the motion eigenvector obtained through the cascade denoising, to obtain the virtual object motion.

11. The method according to claim 10, wherein the cascade denoising network is obtained through a training operation, and the training operation comprises:
obtaining a plurality of training samples; and
training, for each training sample in the plurality of training samples, an initial denoising network according to sample description text and a motion sequence in the training sample to obtain the cascade denoising network.

12. The method according to claim 11, wherein the training the initial denoising network according to sample description text and the motion sequence in the training sample to obtain the cascade denoising network comprises:
parsing the sample description text in the training sample at the plurality of semantic levels through semantic analysis to obtain respective sample description information of the plurality of semantic levels;
separately encoding the sample description information of the plurality of semantic levels to obtain respective sample description representations of the plurality of semantic levels; and
training the initial denoising network based on the sample description representations of the plurality of semantic levels and the motion sequence in the training sample to obtain the cascade denoising network.

13. The method according to claim 12, wherein the training the initial denoising network based on the sample description representations of the plurality of semantic levels and the motion sequence in the training sample to obtain the cascade denoising network comprises:
separately performing motion encoding at a plurality of encoding levels on the motion sequence in the training sample to obtain implicit motion representations respectively corresponding to the plurality of semantic levels; and
training the initial denoising network based on the sample description representations of the plurality of semantic levels and the implicit motion representations respectively corresponding to the plurality of semantic levels to obtain the cascade denoising network.

14. The method according to claim 13, wherein the plurality of encoding levels and the plurality of semantic levels are in one-to-one correspondence, encoding dimensions of the plurality of encoding levels are in ascending order from the first encoding level to the last encoding level, and the separately performing motion encoding at a plurality of encoding levels on the motion sequence in the training sample comprises:
separately performing motion encoding at the plurality of encoding levels on the motion sequence in the training sample to obtain respective motion implicit space features of the plurality of encoding levels; and
separately decoding the motion implicit space features of the plurality of encoding levels to obtain the implicit motion representations respectively corresponding to the plurality of semantic levels.

15. The method according to claim 13, wherein the initial denoising network comprises a plurality of cascaded initial denoisers, each initial denoiser corresponds to one semantic level, and
the training the initial denoising network based on the sample description representations of the plurality of semantic levels and the implicit motion representations respectively corresponding to the plurality of semantic levels comprises:
training, for each initial denoiser in the plurality of initial denoisers, the initial denoiser based on respective sample description representations of at least two semantic levels from the first semantic level to a target semantic level corresponding to the initial denoiser and an implicit motion representation corresponding to the target semantic level, to obtain a trained denoiser; and
obtaining the cascade denoising network according to trained denoisers respectively corresponding the plurality of initial denoisers.

16. The method according to claim 15, wherein the training the initial denoiser based on respective sample description representations of at least two semantic levels from the first semantic level to a target semantic level corresponding to the initial denoiser and an implicit motion representation corresponding to the target semantic level comprises:
obtaining a noising step ranking for adding noise, and obtaining a random noise signal through sampling;
adding, according to the noising step ranking, the random noise signal to the implicit motion representation corresponding to the target semantic level, to obtain a noise motion representation;
inputting the noise motion representation, the noising step ranking, and the sample description representations of the at least two semantic levels from the first semantic level to the target semantic level corresponding to the initial denoiser to the initial denoiser, and predicting the added noise using the initial denoiser, to obtain second predicted added noise; and
performing parameter adjustment on the initial denoiser according to the second predicted added noise to obtain the trained denoiser.

17. The method according to claim 16, wherein the inputting the noise motion representation, the noising step ranking, and the sample description representations of the at least two semantic levels from the first semantic level to the target semantic level corresponding to the initial denoiser to the initial denoiser, and predicting the added noise using the initial denoiser comprises:
inputting, in response to a previous denoiser being connected in series with the initial denoiser, the noise motion representation, the noising step ranking, the sample description representations of the at least two semantic levels from the first semantic level to the target semantic level corresponding to the initial denoiser, and a reconstructed motion representation outputted by the previous denoiser to the initial denoiser, and predicting the added noise using the initial denoiser, to obtain the second predicted added noise.

18. A virtual object motion generation apparatus, the apparatus comprising:
a memory operable to store computer-readable instructions; and
a processor circuitry operable to read the computer-readable instructions, the processor circuitry when executing the computer-readable instructions is configured to:
obtain motion description text for describing a virtual object motion;
parse the motion description text at a plurality of preset semantic levels through semantic analysis to obtain respective motion description information of the plurality of semantic levels, and obtain a sampled noise signal for generating the virtual object motion;
separately encode the motion description information of the plurality of semantic levels to obtain respective motion description representations of the plurality of semantic levels;
perform denoising processing at a first semantic level in the plurality of semantic levels on the sampled noise signal based on a motion description representation of the first semantic level, to obtain a motion eigenvector outputted by the first semantic level;
perform, at each semantic level after the first semantic level in the plurality of semantic levels, denoising processing on the sampled noise signal based on a motion eigenvector outputted by a previous semantic level and respective motion description representations of at least two semantic levels from the first semantic level to a current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level; and
decode the motion eigenvector obtained through the cascade denoising, to obtain the virtual object motion.

19. The apparatus according to claim 18, wherein the plurality of semantic levels comprise a global motion level, a local motion level, and a motion detail level, and the processor circuitry is configured to:
use the motion description text as motion description information of the global motion level;
extract, from the motion description text, at least one verb and a verb-modifying phrase respectively corresponding to the at least one verb;
use the at least one verb as motion description information of the local motion level; and
use the verb-modifying phrase respectively corresponding to the at least one verb as motion description information of the motion detail level.

20. A non-transitory machine-readable media, having instructions stored on the machine-readable media, the instructions configured to, when executed, cause a machine to:
obtain motion description text for describing a virtual object motion;
parse the motion description text at a plurality of preset semantic levels through semantic analysis to obtain respective motion description information of the plurality of semantic levels, and obtain a sampled noise signal for generating the virtual object motion;
separately encode the motion description information of the plurality of semantic levels to obtain respective motion description representations of the plurality of semantic levels;
perform denoising processing at a first semantic level in the plurality of semantic levels on the sampled noise signal based on a motion description representation of the first semantic level, to obtain a motion eigenvector outputted by the first semantic level;
perform, at each semantic level after the first semantic level in the plurality of semantic levels, denoising processing on the sampled noise signal based on a motion eigenvector outputted by a previous semantic level and respective motion description representations of at least two semantic levels from the first semantic level to a current semantic level, to obtain a motion eigenvector that is obtained through cascade denoising at the plurality of semantic levels, motion granularities represented by motion eigenvectors outputted through denoising processing at the plurality of semantic levels being in descending order from a highest semantic level to a lowest semantic level; and
decode the motion eigenvector obtained through the cascade denoising, to obtain the virtual object motion.
